(19) United States
(12) Patent Application Publication
(10) Pub. No.: US 2024/0386519 A1
(43) Pub. Date: Nov. 21, 2024

(54) SERVICE INFORMATION PROVIDING SYSTEM AND CONTROL METHOD

(71) Applicant: SONY GROUP CORPORATION, TOKYO (JP)

(72) Inventor: MASAMICHI ASUKAI, KANAGAWA (JP)

(21) Appl. No.: 18/785,960

(22) Filed: Jul. 26, 2024

Related U.S. Application Data
(63) Continuation of application No. 16/620,971, filed on Dec. 10, 2019.

(30) Foreign Application Priority Data
Jun. 23, 2017 (JP) 2017-123234

(51) Int. Cl. G06Q 50/40; G06Q 10/02; G06Q 10/0631; G06Q 50/47

(52) U.S. Cl. CPC G06Q 50/40; G06Q 10/02; G06Q 10/06315; G06Q 50/47; G06Q 2240/00

(57) ABSTRACT

The problem relates to a service information providing system that is capable of fulfilling various service requests on the basis of obtained congeniality information of sharing service users without imposing a burden on each user and a sharing service provider, and relates to a control method thereof. A service information providing system operated by a service company that provides a service to a plurality of users who shares the same space in the same time zone, the service information providing system comprising: a storage unit that stores congeniality information indicating congeniality between a plurality of users, the congeniality information being generated on the basis of sensor data obtained by sensing the plurality of users who is using a service; a communication unit that receives a service request from a user; and a control unit that performs control in such a manner that on the basis of congeniality information of congeniality of the user to other users, the congeniality information having already been stored in the storage unit, service provision information corresponding to the service request is provided through the communication unit.

### CROSS REFERENCE TO RELATED APPLICATIONS

The present application is a continuation application of U.S. patent application Ser. No. 16/620,971, filed on Dec. 10, 2019, which is a U.S. National Phase of International Patent Application No. PCT/JP2018/013753 filed on Mar. 30, 2018, which claims priority benefit of Japanese Patent Application No. JP 2017-123234 filed in the Japan Patent Office on Jun. 23, 2017. Each of the above-referenced applications is hereby incorporated herein by reference in its entirety.

### TECHNICAL FIELD

The present disclosure relates to a service information providing system and a control method.

### BACKGROUND ART

Conventionally, with respect to a service in which a plurality of persons shares the same time and space, not only contents of a service but also congeniality to a sharing partner often influences whether the service gives each person an enjoyable time or an uncomfortable time.

With respect to technologies for providing a sharing service, for example, the undermentioned patent document 1 discloses a riding-together vehicle searching system that is capable of searching for a customer who is congenial to a user. In such a vehicle searching system, a person having close properties is recommended as a riding together person. Specifically, matching is performed on the basis of: whether or not the distinction of sex, the age, hobbies, or the family structure agrees with that of the user; whether or not purchase behavior (a time zone for visiting a store, and purchased items) is the same as that of the user; or whether or not a person is near as a geographical condition (a route to a destination).

In addition, the undermentioned patent document 2 discloses a service in which a community to participate is determined on the basis of user relation information indicating relations among a plurality of users. The user relation information includes user's mutual subjective evaluations among the plurality of users (evaluations related to, for example, a character of a partner, congeniality to oneself, and accuracy of partner's information). In the system described in the patent document 2, a score of each community is calculated on the basis of the user relation information, and a community to participate, which matches the user, is recommended.

Moreover, the undermentioned patent document 3 discloses a riding-together taxi system that allocates a taxi to patients who desire riding together at the time of returning home. In such a system, riding-together desiring patients, the in-hospital treatment completion time of which belongs to the same time zone, and the residence of which belongs to the same area, are divided, on a riding capacity basis, into groups. Each divided group is set as a riding-together patient group of the same taxi. In this case, a riding-together patient group can be set in consideration of a request for a vehicle type having special facilities, or smoking permitted or no smoking. In the case of an airborne infectious disease (for example, influenza), such a patient can be excluded from the riding-together patient group.

### CITATION LIST

### Patent Document

Patent Document 1: Japanese Patent Application Laid-Open No. 2015-76028

Patent Document 2: Japanese Patent Application Laid-Open No. 2004-151966

Patent Document 3: Japanese Patent Application Laid-Open No. 2003-216727

### SUMMARY OF THE INVENTION

### Problems to be Solved by the Invention

However, the systems in the prior art require a large amount of user information when a service is used, and impose a large burden on the user side. In addition, since it is necessary to consider congeniality for combinations of many users, a burden imposed on the service provider side also increases.

Accordingly, the present disclosure proposes a service information providing system that is capable of fulfilling various service requests on the basis of obtained congeniality information of sharing service users without imposing a burden on each user and a sharing service provider, and proposes a control method thereof.

### Solutions to Problems

According to the present disclosure, there is proposed a service information providing system operated by a service company that provides a service to a plurality of users who shares the same space in the same time zone, the service information providing system including: a storage unit that stores congeniality information indicating congeniality between a plurality of users, the congeniality information being generated on the basis of sensor data obtained by sensing the plurality of users who is using a service; a communication unit that receives a service request from a user; and a control unit that performs control in such a manner that on the basis of congeniality information of congeniality of the user to other users, the congeniality information having already been stored in the storage unit, service provision information corresponding to the service request is provided through the communication unit.

According to the present disclosure, there is proposed a service information providing system that provides, to a service information providing server operated by a service company that provides a service to a plurality of users who shares the same space in the same time zone, congeniality information of congeniality between the plurality of users who uses the service, the service information providing system including: a storage unit that stores congeniality information indicating congeniality between a plurality of users, the congeniality information being generated on the basis of sensor data obtained by sensing the plurality of users who is using a service; a communication unit that, corresponding to a service request from a user, receives information for identifying the user and other users who enjoy the service together with the user, through the service information providing server; and a control unit that performs control in such a manner that on the basis of congeniality information of congeniality of the user to other users, the congeniality information having already been stored in the storage unit, congeniality information of congeniality of the user to other users who enjoy the service together is provided to the service information providing server through the communication unit.

According to the present disclosure, there is proposed a method for controlling a service information providing system operated by a service company that provides a service to a plurality of users who shares the same space in the same time zone, the method being executed by a processor and including the steps of: receiving a service request from a user by a communication unit; and performing control in such a manner that on the basis of congeniality information of congeniality of the user to other users, the congeniality information having already been stored in a storage unit that stores congeniality information indicating congeniality between a plurality of users, the congeniality information being generated on the basis of sensor data obtained by sensing the plurality of users who is using the service, service provision information corresponding to the service request is provided through the communication unit.

According to the present disclosure, there is proposed a method for controlling a service information providing system that provides, to a service information providing server operated by a service company that provides a service to a plurality of users who shares the same space in the same time zone, congeniality information of congeniality between the plurality of users who uses the service, the method being executed by a processor and including the steps of: storing, in a storage unit, congeniality information indicating congeniality between a plurality of users, the congeniality information being generated on the basis of sensor data obtained by sensing the plurality of users who is using a service; corresponding to a service request from a user, receiving, by a communication unit, information for identifying the user and other users who enjoy the service together with the user, through the service information providing server; and performing control in such a manner that on the basis of congeniality information of congeniality of the user to other users, the congeniality information having already been stored in the storage unit, congeniality information of congeniality of the user to other users who enjoy the service together is provided to the service information providing server through the communication unit.

### Effects of the Invention

As described above, according to the present disclosure, various service requests can be fulfilled on the basis of obtained congeniality information of sharing service users without imposing a burden on each user and a sharing service provider.

It should be noted that the above effects are not necessarily limitative, and along with or instead of the above effects, any effect described in the present description, or other effects that can be grasped from the present description, may be exhibited.

### BRIEF DESCRIPTION OF DRAWINGS

FIG. 1 is a drawing illustrating an outline of an information processing system according to one embodiment of the present disclosure.

FIG. 2 is a diagram illustrating an example of an overall configuration of the information processing system according to the present embodiment.

FIG. 3 is a block diagram illustrating an example of a configuration of a user terminal according to the present embodiment.

FIG. 4 is a block diagram illustrating an example of a configuration of a congeniality management server according to the present embodiment.

FIG. 5 is a block diagram illustrating an example of a configuration of a service providing server according to the present embodiment.

FIG. 6 is a sequence diagram illustrating operation processing of the information processing system according to the present embodiment.

FIG. 7 is a flowchart illustrating operation processing of the congeniality management server according to the present embodiment.

FIG. 8 is a flowchart illustrating operation processing of the congeniality management server according to the present embodiment.

FIG. 9 is a flowchart illustrating matching processing in which congeniality information is taken into consideration according to a first example of the present embodiment.

FIG. 10 is a drawing illustrating an example of routes listed by ordinary matching according to the first example of the present embodiment.

FIG. 11 is a drawing illustrating an example of a route selection screen in a ride-sharing service in the prior art.

FIG. 12 is a drawing illustrating an example of a route selection screen in a ride-sharing service in which congeniality information is taken into consideration according to the first example of the present embodiment.

FIG. 13 is a drawing illustrating an example of a character type according to the first example of the present embodiment.

FIG. 14 is a flowchart illustrating estimation processing of estimating a character type according to the first example of the present embodiment.

FIG. 15 is a drawing illustrating the riding together time according to the first example of the present embodiment.

FIG. 16 is a drawing illustrating an example of a graph of a temporal change in smile degree of a user U1 according to the first example of the present embodiment.

FIG. 17 is a drawing illustrating an example of a graph of a temporal change in heart rate of the user U1 according to the first example of the present embodiment.

FIG. 18 is a flowchart illustrating calculation processing of calculating a congeniality degree according to the first example of the present embodiment.

FIG. 19 is a drawing illustrating an example of a seat recommendation screen in the prior art.

FIG. 20 is a drawing illustrating an example of a seat recommendation screen according to a second example of the present embodiment.

FIG. 21 is a drawing illustrating calculation of a vacant-seat congeniality degree according to the second example of the present embodiment.

### MODE FOR CARRYING OUT THE INVENTION

Preferred embodiments of the present disclosure will be detailed below with reference to the accompanying drawings. It should be noted that components, described herein and on the drawings, having substantially identical functional configurations are provided with identical reference numbers, and explanation thereof will not be repeated. In addition, explanations are made in the following order.
1. Outline of information processing system according to one embodiment of the present disclosure
2. Configuration
2-1. Configuration of user terminal
2-2. Configuration of congeniality management server
2-3. Configuration of service providing server
3. Operation processing
4. Each example
4-1. First example
(4-1-1. Matching processing)
(4-1-2. Estimation processing of estimating character type)
(4-1-3. Calculation processing of calculating congeniality degree)
4-2. Second example
5. Summary

### 1. OUTLINE OF INFORMATION PROCESSING SYSTEM ACCORDING TO ONE EMBODIMENT OF THE PRESENT DISCLOSURE

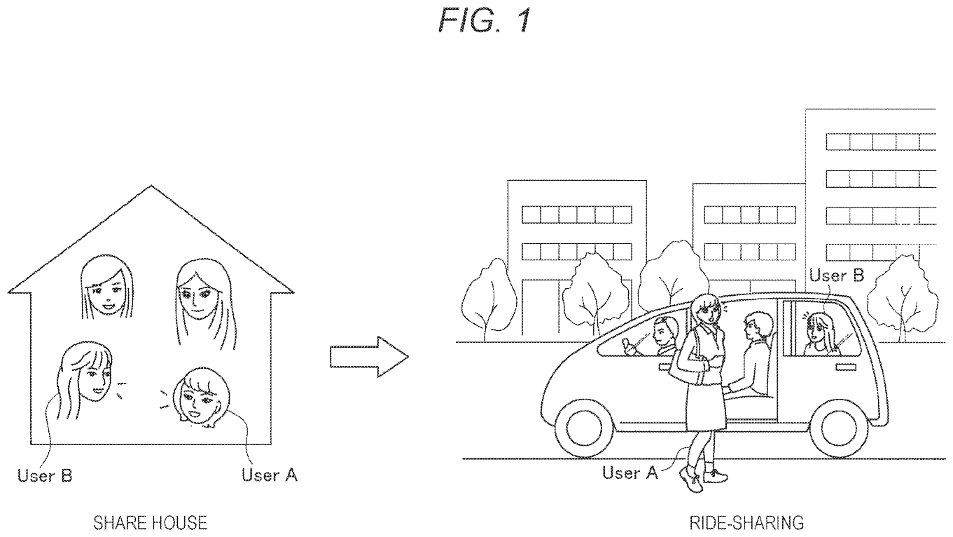

FIG. 1 is a drawing illustrating an outline of an information processing system according to one embodiment of the present disclosure. As shown in FIG. 1, in the information processing system (service information providing system) according to the present embodiment, for example, on the basis of congeniality information of congeniality among users obtained when a sharing service such as a share house is used in the past, when a user uses the same or different sharing service (for example, ride-sharing) next time, matching can be performed to determine a partner who is congenial to the user. The sharing service is a service in which the same space is shared among a plurality of users in the same time zone. In recent years, for example, a share house meaning that a plurality of users shares a house, and ride-sharing that shares riding, are achieving widespread use. In addition, the sharing service in the present description also includes a case where the time and space are shared among a large number of persons (strangers), for example, in an electric train, a bus, a movie theater, or a theater. Moreover, the “space” described here includes not only the actual world but also a virtual world (Virtual Reality (VR)).

More specifically, in the present information processing system, at the time of the first use of a service, congeniality information is generated on the basis of sensing data obtained by sensing users who are using the service, and at the time of the second use of the service, matching can be performed to determine a congenial sharing partner by using the generated congeniality information.

In this manner, in the present information processing system, congeniality among users is estimated by analyzing the sensing data, which eliminates the need for inputting a large amount of user information when the service is applied for, and consequently no burden is placed on the users.

In addition, generation of congeniality information will be described below in detail. However, for example, at the time of the first use of a service, a character or the like of each user is typified on the basis of sensing data obtained by sensing users who are using the service, and congeniality among typified character types is generated as congeniality information. Next, at the time of the second use of the service, a person having a character type congenial to a user's character type may be recommended as a sharing partner on the basis of the generated congeniality information.

Performing congeniality matching on the basis of the typified character types also enables to estimate congeniality among users who have not been brought together in the past, and consequently enables to respond to a service request in various sharing services.

In addition, the present information processing system is capable of performing congeniality matching on the basis of a character type (also referred to as “character type”), which eliminates the need for considering combinations of many users, and consequently no burden is placed on sharing service providers.

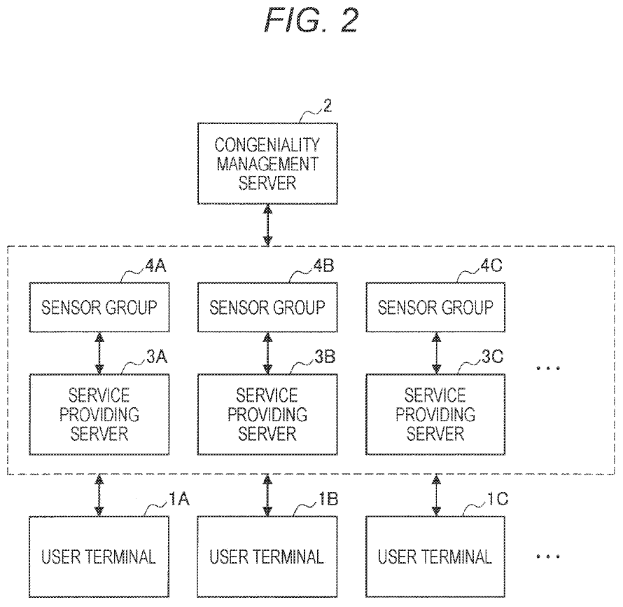

Subsequently, an overall configuration of such an information processing system according to the present embodiment will be described with reference to FIG. 2. FIG. 2 is a diagram illustrating an example of an overall configuration of the information processing system according to the present embodiment.

As shown in FIG. 2, the information processing system according to the present embodiment includes a user terminal 1, a congeniality management server 2, and a service providing server 3.

The user terminal 1 is an information communication terminal used by each user. For example, a smart phone, a portable telephone, a tablet terminal, a personal computer (PC), a wearable device (a smart eyeglass, a smart band, a smart watch, a smart neck speaker, etc.), a music reproducing device, or a game device is assumed as the user terminal 1.

The user connects to the service providing server 3 from the user terminal 1, transmits a service request, and receives information related to service provision or related to being provided with a service.

The congeniality management server 2 generates, and manages congeniality information by analyzing sensing data of each user obtained when a service is used, and provides the congeniality information in response to a request from the service providing server 3.

In response to a service request from the user terminal 1, the service providing server 3 provides the user with a sharing service, or presents information related to sharing service provision to the user. The service providing server 3 is provided corresponding to each sharing service. For example, a service providing server 3A may be a ride-sharing service providing server, a service providing server 3B may be a share house service providing server, and a service providing server 3C may be a movie booking service providing server.

In addition, when a sharing service is provided, the service providing server 3 according to the present embodiment is capable of recommending a congenial partner to a user, and presenting a congeniality degree of a partner to the user, in consideration of congeniality information obtained from the congeniality management server 2.

In addition, the service providing server 3 according to the present embodiment senses a user at the time of using a service by a sensor group 4, and transmits sensing data, or an analysis result of analyzing the sensing data, to the congeniality management server 2. The sensor group 4 may be provided, for example, in a space to be shared. Alternatively, the user terminal 1 may be used as the sensor group 4.

The information processing system according to one embodiment of the present disclosure has been described above. Subsequently, a specific configuration of each unit included in the information processing system according to the present embodiment will be described with reference to the accompanying drawings.

### 2. CONFIGURATION

### 2-1. Configuration of User Terminal 1

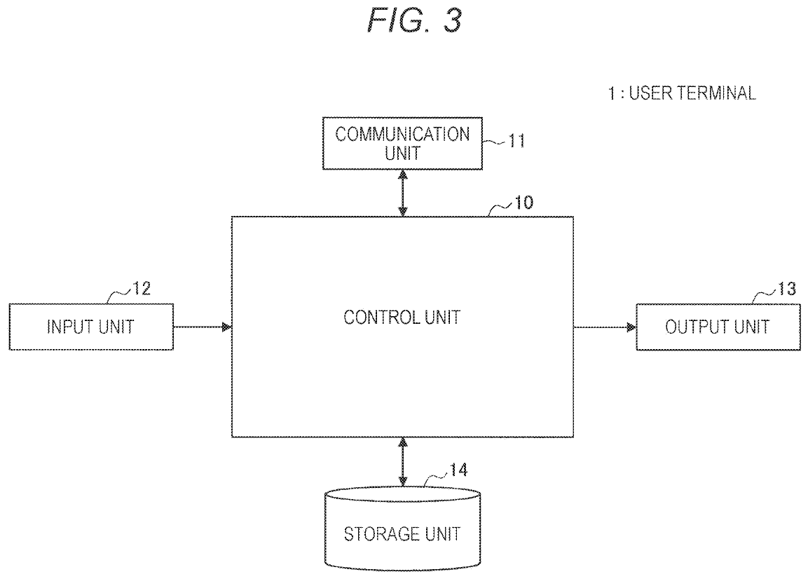

FIG. 3 is a block diagram illustrating an example of a configuration of the user terminal 1 according to the present embodiment. As shown in FIG. 3, the user terminal 1 includes a control unit 10, a communication unit 11, an input unit 12, an output unit 13, and a storage unit 14.

The control unit 10 functions as a computation processing device and a control device, and controls overall operation in the user terminal 1 according to various kinds of programs. The control unit 10 is realized by, for example, an electronic circuit such as a Central Processing Unit (CPU), and a microprocessor. In addition, the control unit 10 may include a Read Only Memory (ROM) for storing a program, a computation parameter, and the like that are used, and a Random Access Memory (RAM) for temporarily storing a parameter and the like that change as appropriate.

Moreover, the control unit 10 according to the present embodiment performs the control in such a manner that a service request requesting use of a predetermined sharing service is transmitted from the communication unit 11 to the service providing server 3 according to operation input by a user. Further, the control unit 10 performs the control in such a manner that service information received from the service providing server 3 is output from the output unit 13 to present the service information to the user.

### Communication Unit 11

The communication unit 11 is wiredly or wirelessly connected to an external device, and transmits/receives data to/from the external device. For example, the communication unit 11 is connected to the service providing server 3 through a network in such a manner that the communication unit 11 transmits/receives data to/from the service providing server 3. In addition, the communication unit 11 is communicably connected to the network 3 by using, for example, a wired/wireless Local Area Network (LAN), or Wi-Fi (registered trademark), a mobile phone communication network (Long Term Evolution (LTE), 3G (the third generation mobile communication method)), or the like.

### Input Unit 12

The input unit 12 has a function of detecting input information input into the user terminal 1, and outputting the input information in the control unit 10. For example, the input unit 12 can be realized by an operation input unit or a voice input unit. The operation input unit accepts an operation instruction by a user, and outputs operation content thereof to the control unit 10. The operation input unit may be a touch sensor, a pressure sensor, or a proximity sensor. Alternatively, the operation input unit may be a physical configuration such as a button, a switch, and a lever.

In addition, the voice input unit is realized by a microphone, a microphone amplification unit that subjects a voice signal obtained by the microphone to amplification processing, and an A/D converter that digitally converts the voice signal. The voice input unit outputs the voice signal to the control unit 10.

### Output Unit 13

The output unit 13 has a function of presenting information output from the control unit 10 to a user. For example, the output unit 13 is realized by a display unit, a projection unit, an audio output unit, a vibration unit, and the like. The display unit is a display device that outputs a screen or the like for allowing the user to input a service request. This display unit may be, for example, a display device such as a liquid crystal display (Liquid Crystal Display (LCD)), and an organic Electro Luminescence (EL) display.
In addition, the audio output unit includes a speaker that reproduces a voice signal, and an amplification circuit for the speaker.

### Storage Unit 14

The storage unit 14 is realized by a Read Only Memory (ROM) for storing a program, a computation parameter, and the like that are used for processing of the control unit 10, and by a Random Access Memory (RAM) for temporarily storing a parameter and the like that change as appropriate.

The configuration of the user terminal 1 according to the present embodiment has been specifically described above. It should be noted that the configuration of the user terminal 1 is not limited to the example shown in FIG. 3. The user terminal 1 may further include, for example, a sensor (an acceleration sensor, a gyro sensor, a terrestrial magnetic sensor, a positioning unit, a living-body sensor, an environment sensor, etc.) that detects a situation of a user at the time of using a service. In this case, the user terminal 1 transmits sensor data obtained by the sensor to the service providing server 3.

### 2-2. Configuration of Congeniality Management Server 2

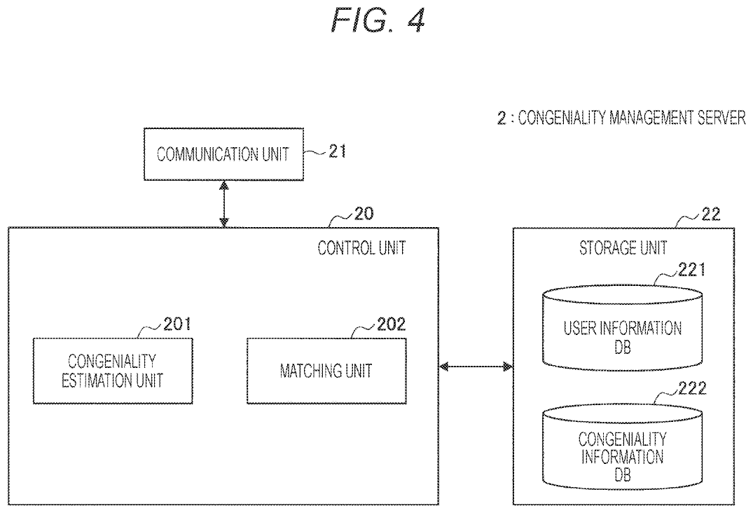

FIG. 4 is a block diagram illustrating an example of a configuration of the congeniality management server 2 according to the present embodiment. As shown in FIG. 4, the congeniality management server 2 includes a control unit 20, a communication unit 21, and a storage unit 22.

### Control Unit 20

The control unit 20 functions as a computation processing device and a control device, and controls overall operation in the congeniality management server 2 according to various kinds of programs. The control unit 20 is realized by, for example, an electronic circuit such as a Central Processing Unit (CPU), and a microprocessor. In addition, the control unit 20 may include a Read Only Memory (ROM) for storing a program, a computation parameter, and the like that are used, and a Random Access Memory (RAM) for temporarily storing a parameter and the like that change as appropriate.

In addition, the control unit 20 according to the present embodiment also functions as a congeniality estimation unit 201 and a matching unit 202.

The congeniality estimation unit 201 estimates congeniality among users on the basis of sensor data of each user sensed when a service is used. For example, a face image that has been image-captured by a camera, a sound that has been acquired by the microphone, living-body sensor data (pulsation, heartbeat, sweating, respiration, etc.) that has been detected by a living-body sensor may be used as sensor data. The congeniality estimation unit 201 analyzes the sensor data, and calculates a congeniality degree of congeniality to a sharer on the basis of user's expression (duration of a smile, etc.), the speaking time (for example, whether or not a talk is livening up), and a heart rate (for example, whether or not a user is in a resting state). The calculated congeniality degree is accumulated in a congeniality information DB 222 together with a congeniality ID, a user ID (the person himself/herself), and a user ID of a partner.

In addition, the congeniality estimation unit 201 is also capable of calculating a congeniality degree on a character type basis. For example, the congeniality estimation unit 201 is also capable of determining a character type of each user on the basis of a questionnaire or sensor data to calculate a congeniality degree of congeniality among character types on the basis of congeniality information of congeniality among users. This also enables to estimate a congeniality degree of congeniality to other users who have not shared in the past.

In response to a request from the service providing server 3, the matching unit 202 performs matching of a sharer congenial to a specific user (sharing service) on the basis of the congeniality information accumulated in the congeniality information DB 222. It should be noted that the control unit 20 according to the present embodiment may be adapted to return not only a result of matching by the matching unit 202, but also congeniality information related to congeniality among a specific user and one or more other users, to the service providing server 3.

### Communication Unit 21

The communication unit 21 is wiredly or wirelessly connected to an external device, and transmits/receives data to/from the external device. For example, the communication unit 21 is connected to the service providing server 3 through a network in such a manner that the communication unit 21 transmits/receives data to/from the service providing server 3. In addition, the communication unit 21 is communicably connected to the external device by using, for example, a wired/wireless Local Area Network (LAN), or Wireless Fidelity (Wi-Fi (registered trademark)) or the like.

### Storage Unit 22

The storage unit 22 is realized by a ROM for storing a program, a computation parameter, and the like that are used for processing of the control unit 20, and by a RAM for temporarily storing a parameter and the like that change as appropriate. For example, the storage unit 22 according to the present embodiment stores a user information DB (database) 221, and a congeniality information DB 222.

User information is accumulated in the user information DB 221. The user information includes, for example, a user ID, a name, and congeniality information (here, a congeniality ID indicating congeniality information).

Congeniality information is accumulated in the congeniality information DB 222. The congeniality information is associated with a congeniality ID, and includes a user ID, a partner user ID, and a congeniality degree. It should be noted that in the present embodiment, congeniality information of congeniality between individual users includes a congeniality degree viewed from one user, and a congeniality degree viewed from the other user. For example, as “congeniality information of congeniality between a user A and a user B”, “a congeniality degree of congeniality to the user B viewed from the user A”, and “a congeniality degree of congeniality to the user A viewed from the user B”, are both calculated.

The configuration of the congeniality management server 2 according to the present embodiment has been specifically described above. It should be noted that the configuration of the congeniality management server 2 shown in FIG. 4 is merely an example, and the present embodiment is not limited to this. For example, at least a part of the configuration of the congeniality management server 2 may be located in an external device, or at least a part of each function of the control unit 20 may be realized by an information processing terminal (for example, a so-called edge server, etc.), the communication distance of which is relatively close to the user terminal 1, or by the service providing server 3. In this manner, distributing each configuration of the congeniality management server 2 as appropriate enables to enhance real-time performance, to reduce a processing load, and further to ensure security.

For example, by causing the congeniality management server 2 to return congeniality information of a specific user in response to a request from the service providing server 3, the service providing server 3 may perform matching of a congenial sharer.

### 2-3. Configuration of Service Providing Server 3

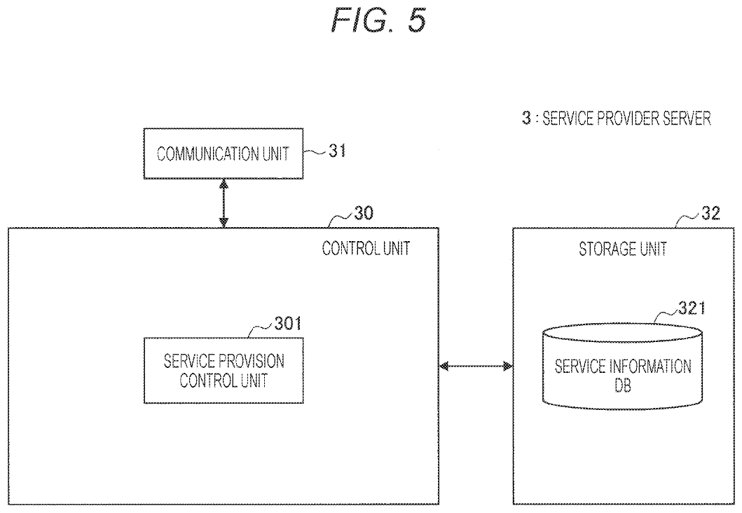

FIG. 5 is a block diagram illustrating an example of a configuration of the service providing server 3 according to the present embodiment. As shown in FIG. 5, the service providing server 3 includes a control unit 30, a communication unit 31, and a storage unit 32.

### Control Unit 30

The control unit 30 functions as a computation processing device and a control device, and controls overall operation in the service providing server 3 according to various kinds of programs. The control unit 30 is realized by, for example, an electronic circuit such as a Central Processing Unit (CPU), and a microprocessor. In addition, the control unit 30 may include a Read Only Memory (ROM) for storing a program, a computation parameter, and the like that are used, and a Random Access Memory (RAM) for temporarily storing a parameter and the like that change as appropriate.

In addition, the control unit 30 according to the present embodiment also functions as a service provision control unit 301. The service provision control unit 301 performs various operation processing related to provision of a sharing service. For example, in the case of a ride-sharing service, in response to a request from a user, the service provision control unit 301 presents the date and time on which a vehicle can be shared, and a traveling route, to the user. In addition, in the case of a share house service, the service provision control unit 301 presents a candidate for a house that can be shared. Moreover, when a candidate for a vehicle or a house to be shared is presented to a user, the service provision control unit 301 according to the present embodiment is also capable of presenting congeniality between the user and a sharer on the basis of congeniality information obtained from the congeniality management server 2. This enables the user to select, for example, a vehicle on which the user takes a ride together with a congenial fellow passenger, and thereby to achieve comfortable ride-sharing. Further, the service provision control unit 301 may be adapted to automatically distribute sharers in such a manner that sharing can be performed in relatively congenial combination on the basis of congeniality information, with the result that comfortable sharing can be performed even if the user does not make a selection.

In addition, the control unit 30 according to the present embodiment receives sensor data, which has been obtained by sensing a user who is using a service by the sensor group 4 (refer to FIG. 2), from the sensor group 4 through the communication unit 31, and transmits the sensor data to the congeniality management server 2 with the sensor data associated with a user ID. The sensor group 4 is provided in, for example, a shared space (inside a vehicle, a house, or the like). More specifically, a camera, a positioning unit, a microphone, a living-body sensor, and the like are assumed as the sensor group 4.

The camera includes: a lens system formed by an image-capturing lens, a diaphragm, a zoom lens, a focusing lens, and the like; a drive system that causes the lens system to perform focus operation and zoom operation; and a solid state image pickup element array that generates an image capturing signal by photoelectrically converting image capturing light obtained by the lens system. The solid state image pickup element array may be realized by, for example, a Charge Coupled Device (CCD) sensor array, or a Complementary Metal Oxide Semiconductor (CMOS) sensor array.

The positioning unit has a function of, on the basis of a signal obtained from the outside, detecting a current position of a place (for example, an automobile) in which the sensor group 4 is provided. Specifically, for example, the positioning unit is realized by a Global Positioning System (GPS) positioning unit, and receives an electrical wave from a GPS satellite to detect a position at which the place exists. In addition, other than GPS, the positioning unit may be a unit that detects a position by using, for example, Wi-Fi (registered trademark), Bluetooth (registered trademark), by transmission and reception to/from a portable telephone, a PHS, a smart phone, or the like, or by short-distance communication or the like.

The living-body sensor is a detection unit that detects user's biological information, and is realized by, for example, a body temperature sensor, a vein sensor, a pulsation sensor, a heartbeat sensor, a perspiration sensor, a brain wave sensor, and the like.

### Communication Unit 31

The communication unit 31 is wiredly or wirelessly connected to an external device, and transmits/receives data to/from the external device. For example, the communication unit 31 is connected to the congeniality management server 2 through a network in such a manner that the communication unit 31 transmits/receives data to/from the congeniality management server 2. In addition, the communication unit 31 is communicably connected to the external device by using, for example, a wired/wireless Local Area Network (LAN), or Wireless Fidelity (Wi-Fi (registered trademark)) or the like.

### Storage Unit 32

The storage unit 32 is realized by a ROM for storing a program, a computation parameter, and the like that are used for processing of the control unit 30, and by a RAM for temporarily storing a parameter and the like that change as appropriate. For example, the storage unit 32 according to the present embodiment stores a service information DB 321. Service information includes information used to provide a sharing service. For example, in the case of ride-sharing, information related to a vehicle (a vehicle ID, a state (in service/empty), a present location, a destination, the estimated arrival time, etc.), and information related to a request from each user (a request ID, an user ID, the request date and time, a present location, a destination, etc.), are accumulated.

The configuration of the service providing server 3 according to the present embodiment has been specifically described above. It should be noted that the configuration of the service providing server 3 shown in FIG. 5 is merely an example, and the present embodiment is not limited to this. For example, at least a part of the configuration of the service providing server 3 may be located in an external device, or at least a part of each function of the control unit 30 may be realized by the user terminal 1, or by an information processing terminal (for example, a so-called edge server, etc.), the communication distance of which is relatively close to the user terminal 1. In this manner, distributing each configuration of the service providing server 3 as appropriate enables to enhance real-time performance, to reduce a processing load, and further to ensure security.

### 3. OPERATION PROCESSING

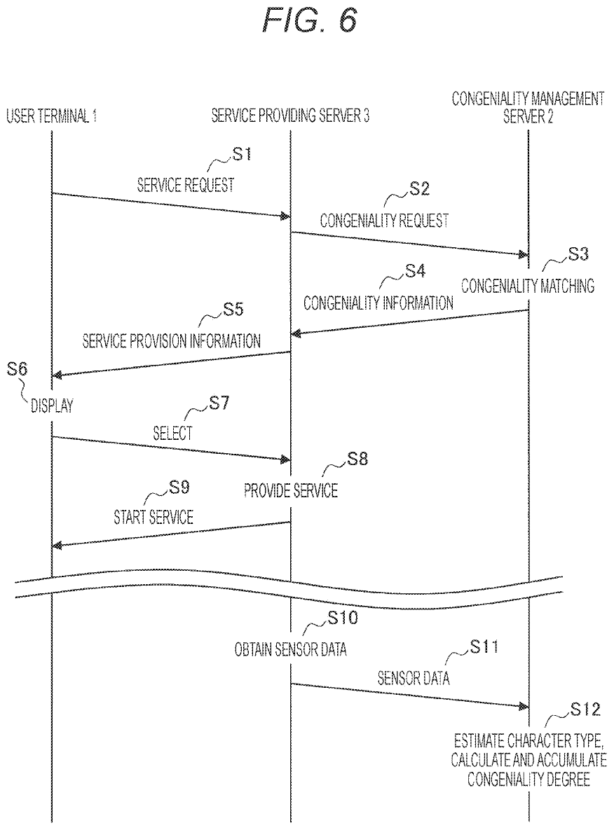

Subsequently, operation processing of the information processing system according to the present embodiment will be described with reference to FIGS. 6 to 8. In the present embodiment, in a sharing service that shares time and a space, congeniality matching is performed in consideration of congeniality between users.

### Overall Flow

FIG. 6 is a sequence diagram illustrating operation processing of the information processing system according to the present embodiment. As shown in FIG. 6, first of all, the user terminal 1 sends a service request to the service providing server 3 that is providing a sharing service which is desired for use (step S1).

Next, in response to a request from a user, the service providing server 3 transmits a congeniality request to the congeniality management server 2, the congeniality request including at least the user, and an ID of another user that becomes a candidate for a sharer of a sharing service requested by the user (step S2).

Next, the congeniality management server 2 performs congeniality matching between requested users (step S3), and returns congeniality information to the service providing server 3 as a matching result (step S4).

Next, the service providing server 3 transmits service provision information based on the matching result to the user terminal 1 (step S5). The service provision information includes at least congeniality information of congeniality to a sharer. For example, in the case of the service providing server 3 that provides a ride-sharing service, the service providing server 3 generates, as service provision information, such a use schedule that does not share the same vehicle in the same time zone with other users who are estimated to be relatively uncongenial, and transmits the service provision information to the user terminal 1.

Next, the user terminal 1 displays the received service provision information to present the service provision information to the user (step S6), and in a case where the presented service is selected by the user (step S7), service provision is started (steps S8, S9). For example, in the case of a ride-sharing service, the user is notified of getting-on time and a getting-on point, and a predetermined automobile is notified of information related to the user.

Moreover, in the present example, sensor data is obtained by sensing a user who is using a service by the sensor group 4 (step S10), and the sensor data is transmitted to the congeniality management server 2 (step S11).

In addition, the congeniality management server 2 calculates a congeniality degree of congeniality between users on the basis of the received sensor data, and accumulates the congeniality degree as congeniality information with the congeniality degree associated with a user ID or the like (step S12). In this case, by estimating a character type of each user, the congeniality management server 2 may accumulate, as a congeniality degree of congeniality between character types, congeniality information that is associated with the character type. The accumulated congeniality information can be used at the time of next congeniality matching.

In this manner, in the present example, in response to a service request, congeniality matching with a candidate for a sharer is performed by using congeniality information obtained by analyzing sensor data sensed during the use of sharing services in the past. Consequently, a more comfortable sharing service can be provided. In addition, congeniality matching can be performed on the basis of a character type even between users who have not been brought together in the past.

### Operation Processing of Congeniality Management Server 2

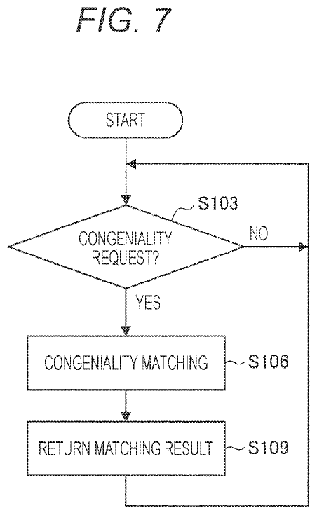

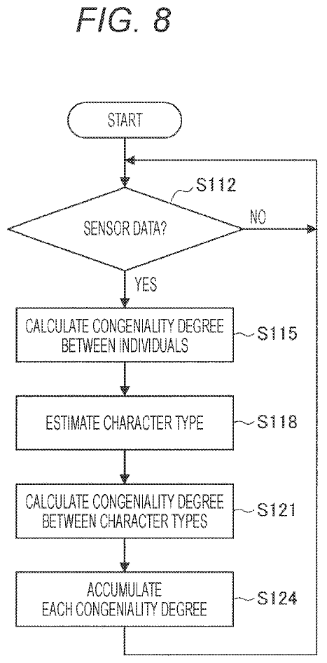

Next, operation processing of the congeniality management server 2 according to the present embodiment will be specifically described. FIGS. 7 and 8 are flowcharts each illustrating operation processing of the congeniality management server 2.

As shown in FIG. 7, in a case where a congeniality request has been received from the service providing server 3 (step S103/YES), on the basis of accumulated congeniality information, the congeniality management server 2 performs congeniality matching between users designated by the congeniality request (step S106).

Next, the congeniality management server 2 returns a result of the congeniality matching to the service providing server 3 (step S109).

In addition, as shown in FIG. 8, in a case where sensor data obtained by sensing a user who is using a service has been received from the service providing server 3 (step S112/YES), the congeniality estimation unit 201 of the congeniality management server 2 calculates a congeniality degree of congeniality between individual users (step S115).

Next, the congeniality estimation unit 201 estimates a character type of each user (step S118), and calculates a congeniality degree of congeniality between character types with reference to the congeniality degree of congeniality between individual users (step S121). In addition, the congeniality estimation unit 201 accumulates each calculated congeniality degree in the congeniality information DB 222 as congeniality information (step S124). Specifically, the congeniality estimation unit 201 accumulates the congeniality degree of congeniality between individual users with the congeniality degree associated with a user ID, and accumulates the congeniality degree of congeniality between character types with the congeniality degree associated with a character type.

The congeniality management server 2 according to the present embodiment is capable of accumulating congeniality degrees, and is capable of performing congeniality matching using the accumulated congeniality degrees, by repeating both congeniality matching processing shown in FIG. 7 and congeniality degree calculation processing shown in FIG. 8.

### 4. EACH EXAMPLE

Subsequently, the information processing system according to the present embodiment will be specifically described by using a plurality of examples.

### 4-1. First Example

In a first example, with respect to a ride-sharing service, provision of a service (route searching, etc.) based on congeniality matching will be described. In the present example, for example, such a use schedule that does not share the same vehicle in the same time zone with other users who are estimated to be relatively uncongenial can be provided to a user as service provision information.

Basic configuration and operation processing according to the present example are as shown in FIGS. 2 to 8, and therefore characteristic configuration and operation processing of the present example will be described here.

### (4-1-1. Matching Processing)

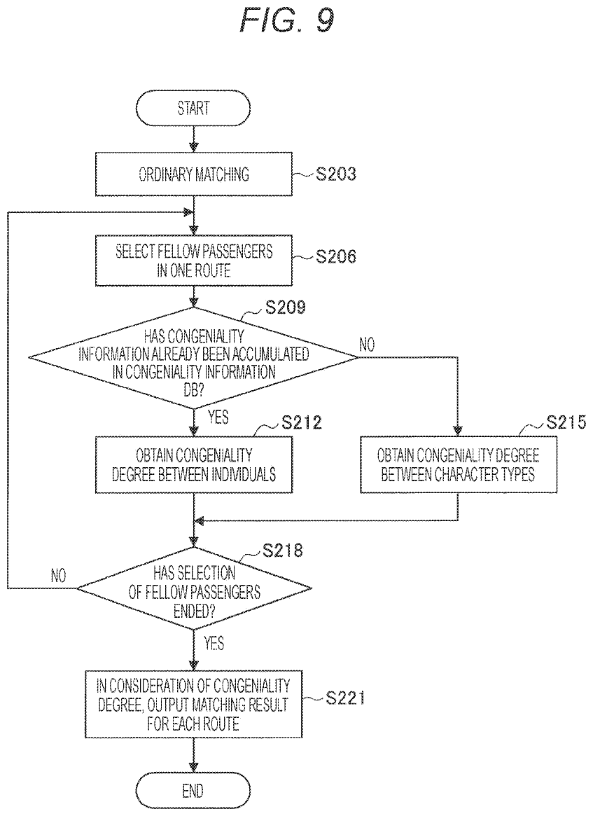

FIG. 9 is a flowchart illustrating matching processing in which congeniality information is taken into consideration according to the present example.

As shown in FIG. 9, first of all, in a case where a request for ride-sharing has been received from a user, the service providing server 3 performs ordinary matching processing in response to the request (step S203). The request includes “a user ID, the time, a user's present location, and a destination”. The service providing server 3 lists routes of sharable vehicles with reference to service information accumulated in the service information DB 321, and request information from other users.

Here, an example of the service information accumulated in the service information DB 321 is shown in the undermentioned tables 1 and 2. As shown in the undermentioned tables 1 and 2, the service information includes information related to a vehicle to be ride-shared, and information related to a request for ride-sharing.

The information related to a vehicle to be ride-shared includes, for each vehicle ID, a state indicating whether the vehicle is in service or empty, a present location, and in a case where the state is in service, a destination and the estimated arrival time. In addition, the information related to a request includes, for each request ID, a user ID, the time, a present location, and a destination.

TABLE 1

| | | Present | | Estimated |
|---|---|---|---|---|
| Vehicle ID | State | location | Destination | arrival time |
| S1 | In service | Present | Destination S1 | Arrival time |
| | | location S1 | | S1 |
| S2 | Empty | Present | — | — |
| | | location S2 | | |
| . . . | . . . | . . . | . . . | . . . |

TABLE 2

| | | | Present | |
|---|---|---|---|---|
| Request ID | User ID | Time | location | Destination |
| R1 | U1 | Time U1 | Present | Destination U1 |
| | | | location U1 | |
| R2 | U2 | Time U2 | Present | Destination U2 |
| | | | location U2 | |
| R2 | U3 | Time U3 | Present | Destination U3 |
| | | | location U3 | |
| . . . | . . . | . . . | . . . | . . . |

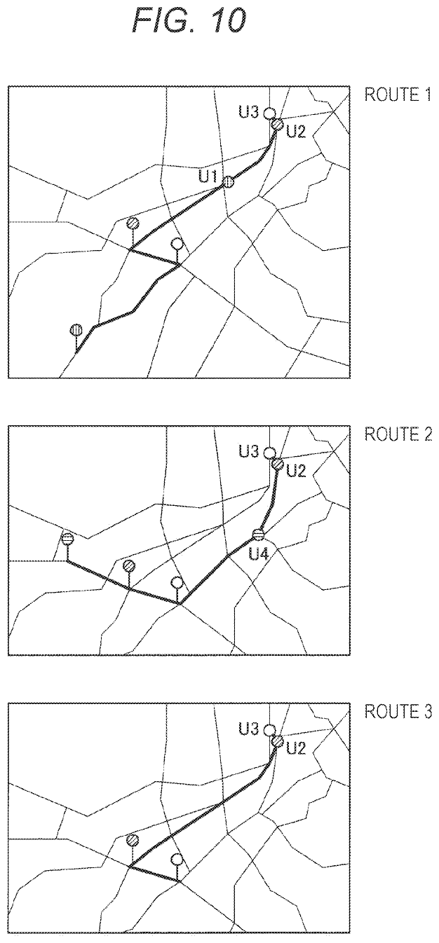

Along with listing of routes, the service providing server 3 may calculate a fare of each route, the getting-on time, the getting-off scheduled time, and the number of persons who ride together. Here, an example of the listed routes is shown in FIG. 10. The example in FIG. 10 shows a route listed in a case where a request has been received from, for example, a user U2. As shown in FIG. 10, a route 1 is a route along which a user U1, the user U2, and a user U3 ride together, a route 2 is a route along which the user U2, the user U3, and a user U4 ride together, and a route 3 is a route along which the user U2 and the user U3 ride together. A riding position and a getting-off position of each user are indicated along each route.

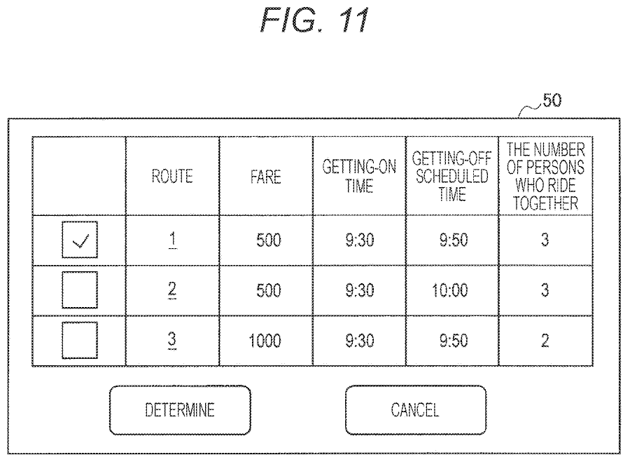

In a case where routes are listed in ordinary matching in this manner, a selection screen 50 as shown FIG. 11 is displayed on the user terminal 1 in the prior art. The selection screen 50 displays a fare of each route, the getting-on time, the getting-off scheduled time, and the number of persons who ride together, and displays a determination button and a cancel button. The user (U2) used to select an arbitrary route on the basis of such information.

However, in the conventional service system, congeniality to other ride-sharing users is not taken into consideration, and therefore there was also a high possibility that the user (U2) will not be able to comfortably spend time.

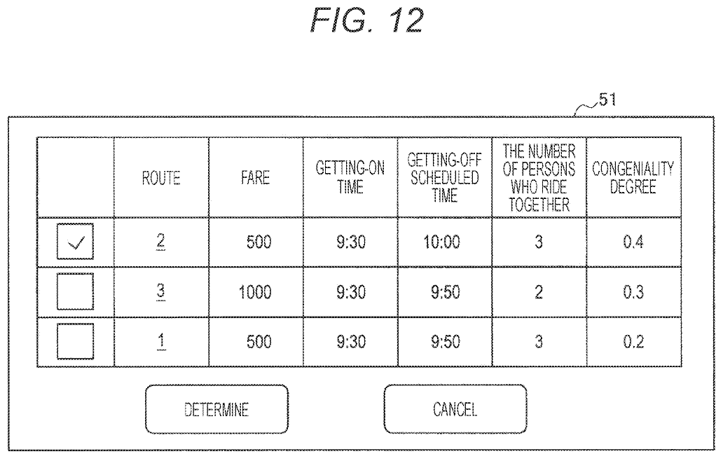

Accordingly, in the present example, in consideration of the result of congeniality matching, a selection screen 51 that also presents a congeniality degree of congeniality to fellow passengers for each route is presented as shown in FIG. 12. This enables the user to select a route in consideration of not only a fare, the time, and the number of persons who ride together, but also a congeniality degree of congeniality to fellow passengers, the congeniality degree influencing whether or not ride-sharing can be comfortably achieved.

In order to calculate such a congeniality degree for each route (for each vehicle), the service providing server 3 obtains the congeniality degree of congeniality between the user and fellow passengers in each route from the congeniality management server 2.

Specifically, first of all, the service providing server 3 selects fellow passengers of one route (for example, in the case of a route 1, “the user U1, the user U2 and the user U3”) (step S206). IDs of the selected fellow passengers are transmitted to the congeniality management server 2 with the IDs included in the congeniality request.

Next, the congeniality management server 2 determines whether or not congeniality information of congeniality between the requested fellow passengers has already been accumulated in the congeniality information DB 222 (step S209). This is because in a case where the congeniality information has already been accumulated, the congeniality degree applied to riding together in the past can be used. The congeniality management server 2 refers to user information stored in the user information DB 221 on the basis of a user ID, and determines whether or not congeniality information of congeniality between the requested fellow passengers exists therein. Here, an example of the user information stored in the user information DB 221 is shown in the following table 3.

TABLE 3

| | | Character | |
|---|---|---|---|
| User ID | Name | type | Congeniality information |
| U1 | ◯◯◯◯ | 10 | US: [C1], U6: [C9, C12] |
| U2 | □□◯◯ | 01 | U1: [C2], U42: [C13, C41, C63] |
| . . . | . . . | . . . | . . . |

As shown in the above-described table 3, the user information includes a user ID, a name, a character type, and congeniality information. With respect to the “congeniality information”, congeniality information related to congeniality to other users who have ridden together in the past is provided as a list of congeniality IDs for each partner user who has ridden together. For example, the above-described table 3 reveals that the user U1 has ridden together with the user U2 once, and together with the user U6 twice.

In a case where the congeniality information has already been accumulated in the user information DB 221 (step S209/Yes), the congeniality management server 2 obtains a congeniality degree of congeniality between sharer individuals from the congeniality information DB 222 on the basis of a congeniality ID, and returns the congeniality degree to the service providing server 3 (step S212).

Meanwhile, in a case where the congeniality information has not been accumulated in the user information DB 221 (step S209/No), this means having not ridden together in the past, and therefore the congeniality management server 2 obtains a congeniality degree on the basis of a character type of a sharer, and returns the congeniality degree to the service providing server 3 (step S215).

In the present example, the “congeniality information” accumulated in the congeniality information DB 222 includes congeniality information of congeniality between individuals, and congeniality information of congeniality between character types. Here, an example of the congeniality information of congeniality between individuals is shown in the following table 4.

TABLE 4

| Congeniality | | Person | | Congeniality |
|---|---|---|---|---|
| ID | Date and time | himself/herself | Partner | degree |
| C1 | 2017 May 14 | U1 | U2 | 0.8 |
| C2 | 2017 May 14 | U2 | U1 | 0.1 |
| C3 | 2017 May 16 | U13 | U2 | 0.7 |
| C4 | 2017 May 16 | U2 | U13 | 0.5 |
| . . . | . . . | . . . | . . . | . . . |

The congeniality information of congeniality between individuals includes a congeniality ID, the date and time (the date and time on which a sharing service has been used, etc.), a user ID (person himself/herself), a user ID of a sharer (partner), and a calculated congeniality degree. Since congeniality to a partner is not always symmetric, congeniality information is accumulated from both sides. For example, when the user U1 and the user U2 perform ride-sharing with each other, a congeniality degree of the user U1 to the user U2 is “0.8”, which reveals that the user U1 has spent time enjoyably. However, a congeniality degree of the user U2 while riding together with the user U1 is “0.1”, which reveals that the user U2 has spent time uncomfortably. It should be noted that the congeniality management server 2 may be adapted to obtain the latest data by priority by referring to date and time information.

Meanwhile, the congeniality information of congeniality between character types is used when congeniality to a partner who has not ridden together in the past is obtained. This congeniality information indicates a standard congeniality degree of each character type for a certain character type. Here, an example of the congeniality information of congeniality between character types is shown in the undermentioned table 5. The character types will be described in detail below. However, for example, congeniality degrees among four character types (00, 01, 10, 11) are described, and these congeniality degrees may be corrected (updated) on the basis of the congeniality information of congeniality between individuals.

TABLE 5

Character type (partner)

| | | 00 | 01 | 10 | 11 |
|---|---|---|---|---|---|
| Character | 00 | 0.8 | 0.9 | 0.4 | 0.5 |
| type (person | 01 | 0.4 | 0.5 | 0.2 | 0.3 |
| himself/ | 10 | 0.5 | 0.5 | 0.9 | 0.9 |
| herself) | 11 | 0.3 | 0.3 | 0.5 | 0.5 |

Subsequently, when selection of fellow passengers ends (in other words, when congeniality degrees of all fellow passengers have been obtained from the congeniality management server 2) (step S218/Yes), the service providing server 3 outputs a matching result for each route in consideration of the congeniality degrees (step S221). For example, the service providing server 3 may calculate an average of congeniality degrees of all fellow passengers (sharing partners) for each route in such a manner that the average is presented as a congeniality degree for each route as shown in FIG. 12. It should be noted that the matching result for each route in consideration of the congeniality degree may be calculated by the congeniality management server 2.

Here, calculation of a congeniality degree for each route will be described using a specific example.

For example, in the case of the route 1 (refer to FIG. 10) listed in response to a request of the user U2, fellow passengers are the user U1 and the user U3. As shown in the above-described tables 3 and 4, it is revealed that a congeniality degree of the user U2 to the user U1 is “0.1”. In addition, a congeniality degree of the user U2 to the user U3 does not exist in the congeniality information of the table 4, and therefore is estimated on the basis of character types. For example, in a case where a character type of the user U2 is “01” and a character type of the user U3 is “11”, referring to the above-described table 5, it is revealed that a congeniality degree of the user U2 to the user U3 is “0.3”.

A congeniality degree of the route 1 is calculated to be “0.2” on the basis of an average of these congeniality degrees.

The congeniality degree of the route 1=(0.1+0.3)/2=0.2

In addition, with respect to a congeniality degree of the route 2, in a case where a character type of the user U4 is, for example, “01”, a congeniality degree of the user U2 to the user U4 is “0.5”, and therefore an average of congeniality degrees becomes “0.4”.

The congeniality degree of the route 2=(0.3+0.5)/2=0.4

Similarly, a congeniality degree of the route 3 becomes “0.3”.

The congeniality degree of the route 3=(0.3)/1=0.3

Incidentally, in the example described above, the congeniality degree has been calculated only from a combination of fellow passengers as an example. However, even in the case of a low congeniality degree, in a case where a riding together distance is short (in other words, in a case where the riding together time is short), it is estimated that an uncomfortableness is reduced in comparison with a case where the riding together distance is long.

Therefore, the congeniality degree may be calculated, for example, by carrying out weighting corresponding to distance.

As a specific example, for example, on the assumption that a getting-on distance of the user U2 of the route 1 is 1.0, in a case where a riding together distance with the user U1 is 0.4 and a riding together distance with the user U3 is 1.0, the congeniality degree of the route 1 is calculated to be “0.17”.

The congeniality degree of the route 1=(0.1*0.4+0.3*1.0)/2=0.17

In addition, for example, in a case where a riding together distance with the user U3 is 0.8, and a riding together distance with the user U4 is 0.6, in the route 2, the congeniality degree of the route 2 is calculated to be “0.47”.

The congeniality degree of the route 2=(0.3*0.8+0.5*0.6)/2=0.27

Moreover, in a case where a riding together distance with the user U3 is 1.0in the route 3, the congeniality degree of the route 3 is referred to as “0.3”.

The congeniality degree of the route 3=(0.3*1.0)/1=0.3

With respect to the congeniality degree of each route, the method in which an average is simply calculated, and the method in which the congeniality degree is calculated by carrying out weighting corresponding to distance, have been described above. It should be noted that the calculation methods according to the present example are not limited to them. The calculation method may be, for example, a method in which the congeniality degree is calculated by carrying out weighting corresponding to the distinction of sex, for example, the same sex is agreeable, a method in which the congeniality degree is calculated by carrying out weighting corresponding to the position and distance of a seat, for example, the next seat is disagreeable, or a method in which the congeniality degree is calculated by carrying out weighting corresponding to the number of persons who ride together, for example, riding together with one person alone is disagreeable. In addition, the congeniality degree may be calculated by combining these methods as appropriate. As the result, for example, when it is necessary to provide such a service in which a user shares the same vehicle in the same time zone with another user who is estimated to be relatively uncongenial to the user, such a use schedule in which still another user also rides together can also be provided as service provision information. Moreover, such a use schedule in which a user does not have a seat next to another user who is estimated to be relatively uncongenial to the user can also be provided as service provision information.

### (4-1-2. Estimation Processing of Estimating Character Type)

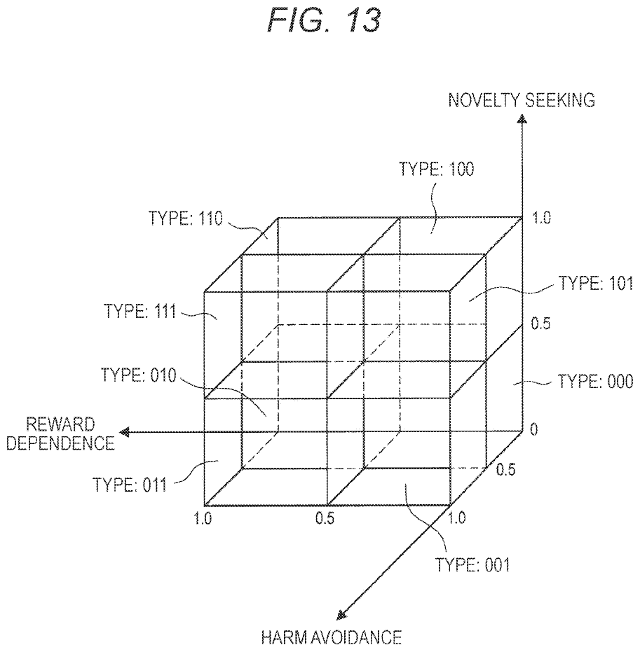

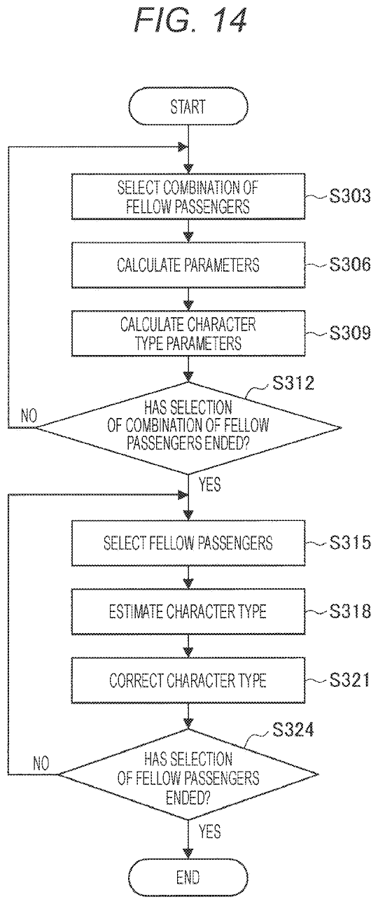

Subsequently, estimation processing of estimating a character type according to the present example will be described with reference to FIGS. 13 to 14. A character type is estimated, for example, on the basis of sensor data obtained by sensing a user while a service is used.

### Character Type

Here, first of all, the definition of “character” according to the present example will be described. When the character of a person is explained, two ways of thinking, for example, typology and trait theory, are used. In the typology, the character is explained by some typical types, and in the trait theory, the character is explained as a combination of some traits. In addition, there is also a case where personality, which is character in a broader sense, is categorized into a congenital temperament and an acquired character. In the present example, as an example, a personality theory, which is a trait theory of Robert Cloninger, is used.

In such a personality theory, characters are categorized from seven traits in total (so-called personality seven dimensions model), which include: four temperament parameters “novelty seeking, reward dependence, harm avoidance, and persistence”; and three character parameters “self-directedness, co-operativeness, self-transcendence”.

With respect to relevance of each trait of temperament parameters to neurotransmitters, such a study has been carried out that novelty seeking is associated with dopamine that is a neurotransmitter, reward dependence is associated with norepinephrine, and harm avoidance is associated with serotonin.

In the present example, a three-dimensional space such as that shown in FIG. 13 is assumed by treating three temperament parameters, which are novelty seeking, reward dependence and harm avoidance, as axes, and the undermentioned eight character types are defined by normalizing each of the axes of novelty seeking, reward dependence and harm avoidance to 0 to 1.

Character type 000—an “independent” type in which novelty seeking, reward dependence, and harm avoidance are low

Character type 001—a “logical” type in which novelty seeking and reward dependence are low, and harm avoidance is high

Character type 011—a “careful” type in which novelty seeking is low, and reward dependence and harm avoidance are high

Character type 111—a “nervous” type in which novelty seeking, reward dependence, and harm avoidance are high

Character type 010—an “earnest” type in which novelty seeking and harm avoidance are low, and reward dependence is high

Character type 110—a “passionate person” type in which novelty seeking and reward dependence are high, and harm avoidance is low

Character type 100—an “adventurer” type in which novelty seeking is high, and reward dependence and harm avoidance are low

Character type 101—a “hot-blooded person” type in which novelty seeking and harm avoidance are high, and reward dependence is low

It should be noted that in order to simplify the explanation below, an explanation will be made using the undermentioned four types that use reward dependence and harm avoidance as two axes.

Character type 00—a type in which reward dependence and harm avoidance are low

Character type 01—a type in which reward dependence is low, and harm avoidance is high

Character type 11—a type in which reward dependence and harm avoidance are high

Character type 10—a type in which harm avoidance is low, and reward dependence is high

### Estimation Processing

FIG. 14 is a flowchart illustrating estimation processing of estimating a character type according to the present example. As shown in FIG. 14, first of all, when sensor data of each user who is using a service is obtained, the congeniality management server 2 selects a combination of fellow passengers (step S303), and calculates, from the sensor data, parameters corresponding to the selected combination (step S306). It is assumed that parameters calculated from the sensor data includes, for example, the smile time, the smile cooccurrence time, the eye-closing time, and the like calculated from a captured image captured while riding by a camera, or the speaking time, a speaking time ratio, and the like calculated from voice data collected by a microphone while riding, and a pulsation average value, a value of change in pulsation, and the like based on a pulsation value detected by a pulsation sensor. The details will be described later.

Next, the congeniality management server 2 calculates character type parameters on the basis of the above-described parameters (step S309). The character type parameters are parameters for determining a character type. Here, “reward dependence” and “harm avoidance” are calculated as an example. The details will be described later.

Subsequently, the processing shown in the above-described steps S303 to S309 is performed for combinations of all fellow passengers (step S312). For example, in a case where the user 2 rides together with the user U1 and the user U3, various parameters (smile time, etc.) during the time during which the user 2 rides together with the user U1 are calculated from the sensor data, and character type parameters are calculated. Moreover, various parameters (smile time, etc.) during the time during which the user 2 rides together with the user U3 are also calculated from the sensor data, and character type parameters are calculated.

In addition, various parameters (smile time, etc.) during the time during which the user 1 rides together with the user U2 are calculated from the sensor data, and character type parameters are calculated. Moreover, various parameters (smile time, etc.) during the time during which the user 1 rides together with the user U3 are also calculated from the sensor data, and character type parameters are calculated.

Further, various parameters (smile time, etc.) during the time during which the user 3 rides together with the user U1 are calculated from the sensor data, and character type parameters are calculated. Furthermore, various parameters (smile time, etc.) during the time during which the user 3 rides together with the user U1 are also calculated from the sensor data, and character type parameters are calculated.

In this manner, in a case where three persons ride together, various parameters and character type parameters are calculated on both sides for three combinations (the user 2 and the user 1, the user 2 and the user 3, and the user 1 and the user 3).

Next, the congeniality management server 2 selects one fellow passenger (step S315), estimates a character type of the fellow passenger on the basis of the calculated character type parameters described above (step S318), and corrects (updates) a character type of each user accumulated in the user information DB 221 (step S321).

Subsequently, the congeniality management server 2 repeats the processing of the steps S315 to S321 until all fellow passengers are selected for estimation and correction of character types (step S324).

### Calculation of Parameters from Sensor Data

Subsequently, parameter calculation shown in the step S306 will be described in detail. In the present example, for example, the smile time, a temporal change in smile, the smile cooccurrence time, the eye-closing time, the speaking time, a speaking time ratio, a heart rate (an average value, etc.), a change in heart rate, and the like, while riding are calculated from sensor data obtained by the sensor group 4 (the camera, the microphone, the pulsation sensor, etc.).

For example, when the user U2 selects the above-described route 1, in a case where three persons who are the user U1, the user U2 and the user U3 ride together, parameters are calculated in the following manner.

TABLE 6

| | | | Temporal | Smile | Eye- | | Speaking | |
|---|---|---|---|---|---|---|---|---|
| | Fellow | Smile | change | cooccurrence | closing | Speaking | time | Heart |
| User | passenger | time | in smile | time | time | time | ratio | rate |
| U1 | U2 | TS_{U1U2} | ΔTS_{U1U2} | TCS_{U1U2} | TCE_{U1U2} | TU_{U1U2} | RU_{U1U2} | HR_{U1U2} |
| | U3 | TS_{U1U3} | ΔTS_{U1U3} | TCS_{U1U3} | TCE_{U1U3} | TU_{U1U3} | RU_{U1U3} | HR_{U1U3} |
| U2 | U1 | TS_{U2U2} | ΔTS_{U2U1} | TCS_{U2U1} | TCE_{U2U1} | TU_{U2U1} | RU_{U2U1} | HR_{U2U1} |
| | U3 | TS_{U2U3} | ΔTS_{U2U3} | TCS_{U2U3} | TCE_{U2U3} | TU_{U2U3} | RU_{U2U3} | HR_{U2U3} |
| U3 | U1 | TS_{U3U1} | ΔTS_{U3U1} | TCS_{U3U1} | TCE_{U3U1} | TU_{U3U1} | RU_{U3U1} | HR_{U3U1} |
| | U2 | TS_{U3U2} | ΔTS_{U3U2} | TCS_{U3U2} | TCE_{U3U2} | TU_{U3U2} | RU_{U3U2} | HR_{U3U2} |

During the time during which the user U1 ride together with the fellow passenger (the user U2), “the smile time” indicates a length of time during which the user U1 smiles, and “the smile cooccurrence time” indicates a length of time during which the user U1 and the user U2 both smile together. In addition, “the eye-closing time” indicates a length of time during which the user U1 closes eyes as if the user U1 “pretends to be asleep”, and “the speaking time” indicates a length of time during which the user U1 is speaking.

Moreover, the “speaking time ratio” is a ratio of speaking between the user U1 and the user U2, and the “heart rate” is an average heart rate of the user U1. Further, the “temporal change in smile” and the “change in heart rate” (not illustrated) each indicate an increase or a decrease from the first half to the latter half of the time of riding together.

It should be noted that each parameter is normalized to 0 to 1, the time parameters are normalized by the riding together time, and physiological data such as a heart rate is normalized by a minimum value and a maximum value of each person.

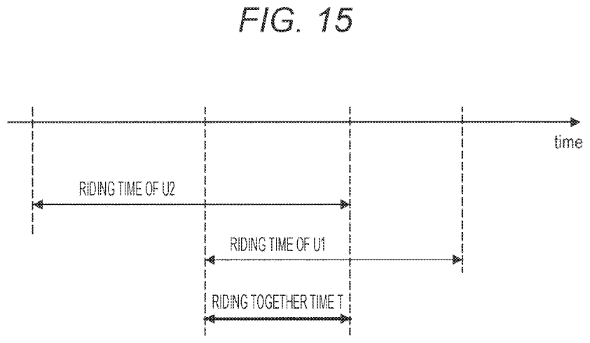

Here, the temporal change in smile will be described in detail. First of all, time T during which the user U1 rides together with the fellow passenger (the user U2) is determined as shown in FIG. 15. In other words, for example, in a case where the user U2 gets on earlier, the user U1 rides together with the user U2, and the user U2 gets off earlier, the time T is the time during which the user U1 and the user U2 ride together as shown in FIG. 15.

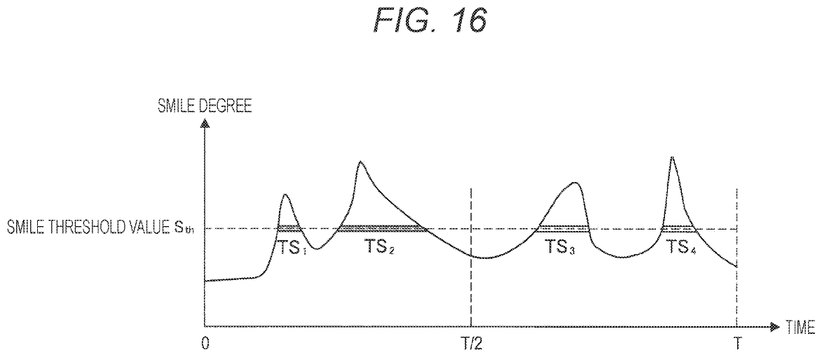

FIG. 16 illustrates a graph of a temporal change in smile degree of the user U1 at this time. As shown in FIG. 16, on the assumption that the time during which a smile degree has exceeded a smile threshold value Sₜₕ in the first half (0<t≤T/2) of the riding together time T is TS_{FH}, and the time during which the smile degree has exceeded the smile threshold value Sₜₕ in the latter half (T/2<t≤T) is TS_{SH}, a temporal change in smile (ΔTS) can be determined, for example, by the following formula 1.

$$\\ \begin{matrix}[ Formula 1 ] & \\ {TS}_{FH} = {\sum }_{i}^{0 < t \leq T / 2} {TS}_{i} & ( Formula 1 )\end{matrix}$$

$$\\ {TS}_{SH} = {\sum }_{i}^{T / 2 < t \leq T} {TS}_{i}$$

$$\\ Δ TS = \frac{( {TS}_{FH} - {TS}_{SH} + T / 2 )}{T}$$

Consequently, for example, when a smile is continuously given in the first half, whereas no smile is given in the latter half, ΔTS becomes 1, and when no smile is given in the first half, whereas a smile is continuously given in the latter half, ΔTS becomes 0. In other words, when a smile is continuously given in the first half, whereas no smile is given in the latter half, it is considered that the smile has been given by force so as not to impair relations with the person in the first half. Therefore, the decrease in smiling in the latter half is evaluated to be positive in the “harm avoidance” that represents suppression of an act.

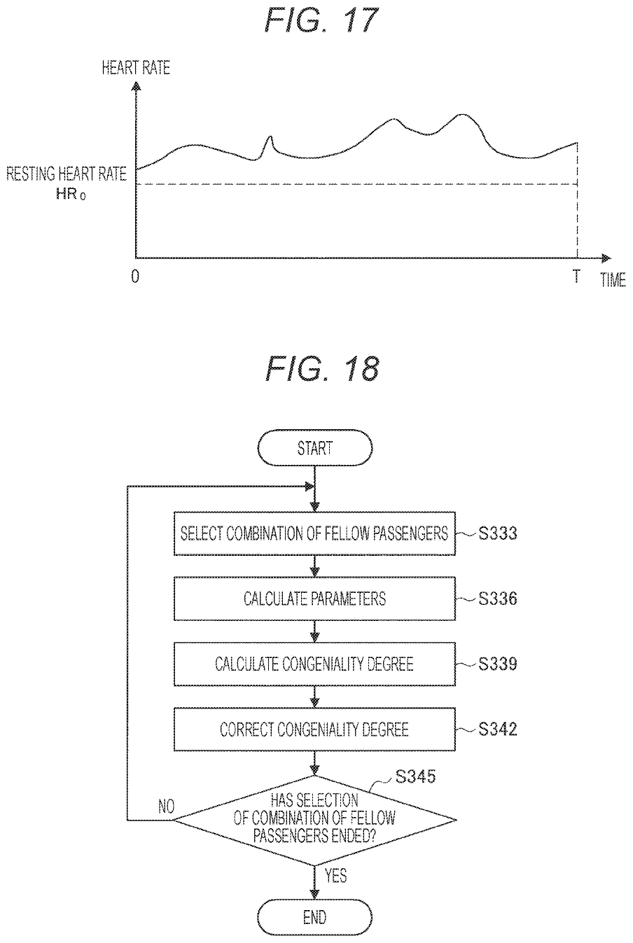

In addition, FIG. 17 illustrates a graph of a temporal change in heart rate of the user U1. As shown in FIG. 17, on the assumption that an average heart rate during the riding together time (0<t≤T) is HRₐᵥᵣ, and a resting heart rate is HR₀, a normalized heart rate HR can be determined, for example, by the following formula 2.

$$\\ \begin{matrix}[ Formula 2 ] & \\ When {HR}_{avr} < {HR}_{0} , HR = 0 & ( Formula 2 )\end{matrix}$$

$$\\ When {HR}_{0} \leq {HR}_{avr} < 1.5 {HR}_{0} , HR = \frac{( {HR}_{avr} - {HR}_{0} )}{0.5 {HR}_{0}}$$

$$\\ When 1.5 {HR}_{0} \leq {HR}_{avr} , HR = 1$$

### Calculation of Character Type Parameter

Next, calculation of character type parameters based on the parameters calculated as described above will be described in detail. In the present example, “reward dependence RD” and “harm avoidance HA” that are character type parameters for determining a character type are determined, for example, by the following formula 3.

$$\\ \begin{matrix}[ Formula 3 ] & \\ RD = {\sum }_{j}^{N} {RD}_{Uj} / N & ( Formula 3 )\end{matrix}$$

$$\\ HA = {\sum }_{j}^{N} {HA}_{Uj} / N$$

$$\\ {RD}_{Uj} = {\sum }_{i} {w}_{RDi} {P}_{i}$$

$$\\ {HA}_{Uj} = {\sum }_{i} {w}_{HAi} {P}_{i}$$

In the above-described formula 3,
RDᵤⱼ: a value (0 to 1) of reward dependence with a fellow passenger Uj
HAᵤⱼ: a value (0 to 1) of harm avoidance with the fellow passenger Uj
Pᵢ: a value (0 to 1) of the i-th parameter calculated from sensor data
W_{RDi}: weighting to reward dependence of the i-th parameter
W_{HAi}: weighting to harm avoidance of the i-th parameter

$$\\ {\sum }_{i} {W}_{RDi} = 1$$

$$\\ {\sum }_{i} {W}_{HAi} = 1$$

In addition, by using the reward dependence RD and the harm avoidance HA that have been calculated, a character type (character type) is determined by the following conditions.
If 0≤RD<0.5 and 0≤HA<0.5, the character type is character type 00
If 0≤RD<0.5 and 0.5≤HA≤1.0, the character type is character type 01
If 0.5≤RD≤1.0 and 0≤HA<0.5, the character type is character type 10
If 0.5≤RD≤1.0 and 0.5≤HA≤1.0, the character type is character type 11

More specifically, for example, reward dependence RD_{U2} of the user U1 during the time during which the user U1 has ridden together with the fellow passenger (the user U2) is calculated, for example, as follows: RD_{U2}=0.5TS_{U1U2}+0.5TCS_{U1U2}+(−0.5)TCE_{U1U2}+0.5TU_{U1U2}

In other words, the reward dependence represents “relations with persons”, such as sociability. Therefore, for example, the reward dependence is evaluated to be positive on the basis of the smile time, the smile cooccurrence time, and the speaking time, and is evaluated to be negative by an act that interrupts relations with persons, the eye-closing time relating to such an act.

Similarly, the harm avoidance HA_{U2} of the user U1 during the time during which the user U1 rides together with the fellow passenger (the user U2) is calculated, for example, as follows: HA_{U2}=0.5ΔTS_{U1U2}+0.5HR_{U1U2}

In other words, the harm avoidance represents “suppression of an act” based on an anxious mind or the like. Therefore, the harm avoidance is evaluated to be positive by, for example, a decrease in smiling or an increase in heart rate, on the basis of the temporal change in smile or the heart rate. For example, with respect to the temporal change in smile, in a case where the smile time in the latter half is shorter than that in the first half during the riding together time, it is considered that the smile has been given by force so as not to impair relations with the person in the first half. Therefore, the decrease in smiling in the latter half is evaluated to be positive. In addition, in a case where a heart rate is higher than usual, it is considered that riding together with other persons causes anxiety. Therefore, this case is evaluated to be positive.

As described above, in the present example, the character type is estimated on the basis of information (sensor data) obtained when the service has been used in the past. However, there is also a case where a character type of a user cannot be estimated, for example, in an early stage in which the user has started using a service. Therefore, each user may be requested to fill in a questionnaire or the like at the time of subscribing the service in such a manner that a character type of the user can be estimated.

For example, the questionnaire includes questions as described below, and the congeniality management server 2 is capable of estimating a character type of each user on the basis of answers to the following questions.

Example of questions of questionnaire:
(1) Even in the case of a matter that is considered to be a waste of time for most people, do you often try a new thing for the sake of an interest and a thrill? <Yes/No>
(2) Even in such a situation that causes most people to be anxious, do you feel confident that everything will go well? <Yes/No>
(3) Are you often deeply touched by an excellent speech or a poem? <Yes/No>

It should be noted that the question (1) relates to novelty pursuit, the question (2) relates to the harm avoidance, and the question (3) relates to the reward dependence. “0/1” of each axis is determined on the basis of “Yes/No” of all questions related to the novelty seeking, the harm avoidance, and the reward dependence, and thereby a character type is determined.

### (4-1-3. Calculation Processing of Calculating Congeniality Degree)

Subsequently, calculation processing of calculating a congeniality degree according to the present example will be described with reference to FIG. 18. A congeniality degree can be calculated, for example, on the basis of sensor data obtained by sensing a user while a service is used.

FIG. 18 is a flowchart illustrating calculation processing of calculating a congeniality degree according to the present example. As shown in FIG. 18, first of all, when sensor data of each user who is using a service is obtained, the congeniality management server 2 selects a combination of fellow passengers (step S333), and calculates, from the sensor data, parameters corresponding to the selected combination (step S336).

As with the parameters used in the character type estimation described above, it is assumed that parameters calculated from the sensor data includes, for example, the smile time, the smile cooccurrence time, the eye-closing time, and the like calculated from a captured image captured while riding by a camera, or the speaking time, a speaking time ratio, and the like calculated from voice data collected by a microphone while riding, and a pulsation average value, a value of change in pulsation, and the like based on a pulsation value detected by a pulsation sensor. Details of the calculation of these parameters are similar to the calculation of the same parameters at the time of calculating the character type, and therefore detailed description thereof will be omitted here.

Next, the congeniality management server 2 calculates a congeniality degree in the combination selected on the basis of parameters (step S339), and corrects (updates) a congeniality degree of each user accumulated in the congeniality information DB 222 (step S342). It should be noted that when congeniality between users is corrected, the congeniality management server 2 may correct (update) congeniality information of congeniality between corresponding character types as well. Details of the calculation of the congeniality degree will be described later.

Subsequently, the congeniality management server 2 repeats the processing of the steps S333 to S342 for combinations of all fellow passengers (step S345).

### Calculation of Congeniality Degree

Next, calculation of a congeniality degree shown in the step S339 will be described using a specific example. In the present example, a congeniality degree from x to y can be calculated by using, for example, the following equation 4.

$$\\ \begin{matrix}[ Formula 4 ] & \\ Congeniality {degree}_{xy} = {\sum }_{i} {W}_{i} {P}_{i} & ( Formula 4 )\end{matrix}$$

where
Pᵢ: a value (0 to 1) of the i-th parameter calculated from sensor data

ΣᵢWᵢ=1

As an example, calculation of a congeniality degree performed in a case where the user U2 selects the route 1 and three persons who are the user U1, the user U2 and the user U3 ride together will be described. Here, the parameters shown in the table 6 are used.

In this case, a congeniality degree of the user U1 to the user U2 during the time during which the user U1 rides together with the user U2 is calculated, for example, as follows: Congeniality degree _{U1U2}=0.3TS_{U1U2}+0.6TCS_{U1U2}+(−0.8)TCE_{U1U2}+0.3TU_{U1U2}+0.6RU_{U1U2}

In other words, the congeniality degree is evaluated to be positive by the smile time, the smile cooccurrence time, the speaking time, and a speaking time ratio, and is evaluated to be negative by the eye-closing time. Incidentally, the speaking time ratio between the user U1 and the user U2 is represented by the following formula 5. The speaking time ratio may be adapted to have a value of 1 when both of the user U 1 and the user U2 equally speak in a well-balanced manner.

$$\\ \begin{matrix}[ Formula 5 ] & \\ {RU}_{U 1 U 2} = 1 - \frac{\vert {TU}_{U 1 U 2} - {TU}_{U 2 U 1} \vert}{{TU}_{U 1 U 2} + {TU}_{U 2 U 1}} & ( Formula 5 )\end{matrix}$$

In this manner, when the user U1 rides together with the user U2, if the user U1 smiles many times, if the user U1 smiles together with the user U2, or if the user U1 often speaks without pretending to be asleep and eventually speaks as frequently as the user 2 does, the congeniality degree increases.

It should be noted that the parameters (the smile time, the smile cooccurrence time, the speaking time, the speaking time ratio, and the eye-closing time) used in the present example are continuously measured while riding. However, parameters used in the present example are not limited to those continuously measured while riding. A parameter that is associated with a specific event that occurs while riding may be used as well. For example, it is also possible to introduce the following parameters: “rapid acceleration/deceleration smile time” that relates to whether or not a user can enjoy rapid acceleration and rapid deceleration; “smile time during traffic jam” that relates to, when a user is caught in a traffic jam while riding, whether or not the user can enjoy the traffic jam without having negative feelings; and the like. In addition, the “rapid acceleration/deceleration smile time” and the “smile time during traffic jam”, each of which is a parameter that is associated with a specific event occurring while riding, can also be used at the time of the estimation of a character type. In this case, “rapid acceleration/deceleration smile cooccurrence time” or “smile cooccurrence time during traffic jam” may be further used.

### 4-2. Second Example

Next, a second example according to the present embodiment will be described. In the first example described above, congeniality information is used for congeniality matching of the same sharing service. However, the present embodiment is not limited to this. Congeniality information obtained when a certain sharing service is used can also be used for congeniality matching in other sharing services.

More specifically, for example, congeniality information obtained from a user of a room-sharing service can be applied to a seat recommendation service of a movie theater. From a service providing server 3B that provides the room-sharing service, the congeniality management server 2 obtains sensor data of the user who is using the service, so as to generate and accumulate congeniality information. In response to a request from a service providing server 3C (seat booking management server) that provides the seat recommendation service of the movie theater, the congeniality management server 2 is capable of performing congeniality matching on the basis of the accumulated congeniality information.

It should be noted that the service providing server 3B is capable of performing congeniality matching in the room-sharing service. For example, replacing the “fellow passengers” in the ride-sharing service of the first example with “house mates” enables to similarly realize calculation of a congeniality degree, and congeniality matching.

Here, an example of service information stored in the service providing server 3B in the case of providing a room-sharing service is shown in the undermentioned tables 7 and 8. The service information includes information related to each room, and information related to a request from each user.

TABLE 7

| Service | | | | | Vacancy |
|---|---|---|---|---|---|
| ID | Name | Location | Fare | State | information |
| S1 | Name | Location | Fare | Occupied | R1: U11, R2: |
| | S1 | S1 | S1 | | U12, R3: U13 |
| S2 | Name | Location | Fare | Vacant | R1: U21, R2: -, |
| | S2 | S2 | S2 | | R3: U23 |
| . . . | . . . | . . . | . . . | . . . | . . . |

TABLE 8

| Request ID | User ID | Contents |
|---|---|---|
| R1 | U1 | Area U1, Fare U1 |
| R2 | U2 | Area U2, Fare U2 |
| . . . | . . . | . . . |

As shown in the table 7, information related to a room includes a service ID, a name, a location, a fare, a state (occupied/vacant), and vacancy information. A user ID of a person who lives together in each room is indicated in the vacancy information. In addition, as shown in the table 8, the request information includes a request ID, a user ID of a user who has requested, and content information related to requested contents. An area and a fare, which are desired by the user, are indicated in the content information.

It should be noted that a data configuration of user information and congeniality information (congeniality information of congeniality between individuals, and congeniality information of congeniality between character types) is similar to that of the first example.

Moreover, an example of service information stored in the service providing server 3C that provides the seat recommendation service of the movie theater is shown in the undermentioned tables 9 and 10. The service information includes information related to each movie theater, and information related to a request from each user.

TABLE 9

| Service | | | | | |
|---|---|---|---|---|---|
| ID | Name | Location | Fare | State | Vacancy information |
| S1 | Name | Location | Fare | Vacant | S1: U31, S2: —, |
| | S1 | S1 | S1 | | S3: U33, . . . |
| . . . | . . . | . . . | . . . | . . . | . . . |

TABLE 10

| Request ID | User ID | Contents |
|---|---|---|
| R1 | U32 | Area U1, Title U1, Time U1 |
| R2 | U24 | Area U2, Title U2, Time U2 |
| . . . | . . . | . . . |

As shown in the table 9, information related to a movie theater includes a service ID, a name, a location, a fare, a state (occupied/vacant), and vacancy information. A user ID of a user who has booked each seat is indicated in the vacancy information.

In addition, as shown in the table 10, the request information includes a request ID, a user ID of a user who has requested, and content information related to requested contents. An area, a movie title, and the scheduled screening time, which are desired by the user, are indicated in the content information.

It should be noted that a data configuration of user information and congeniality information (congeniality information of congeniality between individuals, and congeniality information of congeniality between character types) is similar to that of the first example.

### Congeniality Matching of Room-Sharing

In addition, operation processing of congeniality matching of room-sharing according to the present example is similarly realized by replacing the “fellow passengers” in the operation processing of the congeniality matching of the ride-sharing shown in FIG. 9 with “house mates”.

In other words, when a request of room-sharing is received from a user, on the basis of a user ID, a desired area and a desired fare in the request, the service providing server 3B lists vacant rooms that are located in the desired area as processing of ordinary matching. In the prior art, a screen for presenting “a name, a location, a fare, the number of persons who live together” for each of the listed rooms is presented to a user. However, in the present example, a “congeniality degree” indicating congeniality to house mates of each room can also be presented further on the basis of congeniality matching.

Moreover, as with the first example, the congeniality management server 2 is capable of estimating a character type, and is capable of calculating a congeniality degree, on the basis of sensing data of a user who is using the service. With respect to sensing data obtained while living together, in a case where privacy is taken into consideration, sensing may be carried out only in a shared space. As with the above-described example, it is assumed that parameters calculated from the sensing data include the smile time, the smile cooccurrence time, the eye-closing time, the speaking time, a speaking time ratio, a pulsation value, and a value of change in pulsation.

### Application to Seat Recommendation Service

Subsequently, a case where congeniality information is applied to another sharing service will be described.

First of all, when a request for movie appreciation has been received from a user, the service providing server 3C that provides a seat recommendation service of a movie theater performs ordinary matching processing. In other words, on the basis of a user ID, a desired area, a desired title and the desired time in the request, the service providing server 3C lists movie theaters that are located in the desired area, and have a vacant seat.

In the prior art, a screen for presenting “a name, a location, a fare, and a vacant seat list” for each of the listed movie theaters is presented to the user. However, in the present example, further on the basis of congeniality matching, a “congeniality degree” based on, for example, congeniality to surrounding other users who sit together can also be presented.

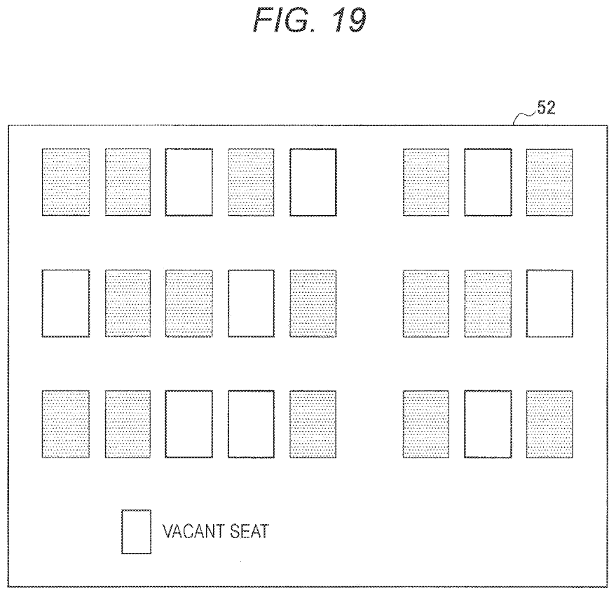

Here, FIG. 19 shows an example of a seat recommendation screen based on matching in the prior art. As shown in FIG. 19, the seat recommendation screen 52 in the prior art merely displays whether or not each seat is vacant. Accordingly, congeniality to surrounding users is not taken into consideration.

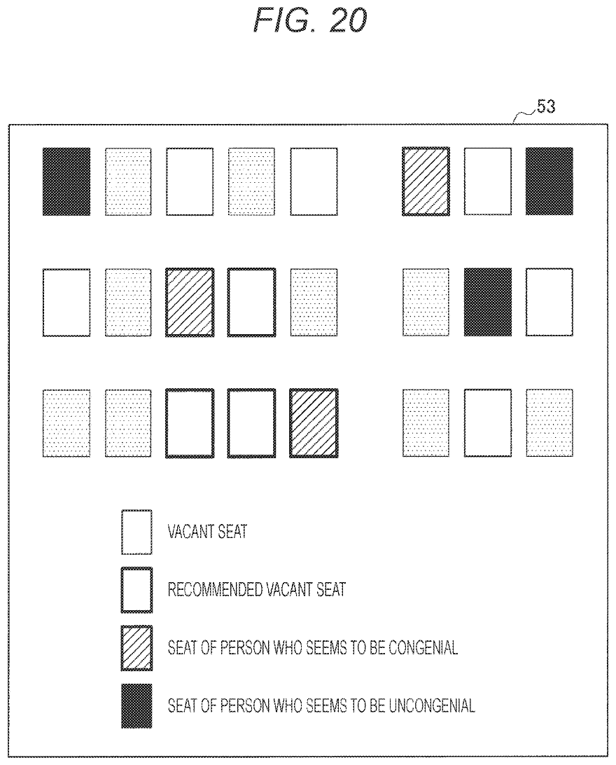

Next, an example of a seat recommendation screen based on congeniality matching according to the present example is shown in FIG. 20. As shown in FIG. 20, on a seat recommendation screen 53 according to the present example, a congeniality degree of congeniality to users who sit on surrounding seats is calculated for each vacant seat. A vacant seat, the congeniality degree of which is higher than or equal to a predetermined value, is indicated with thick lines, and is clearly stated as a “recommended vacant seat”. In addition, as information related to occupied seats, “a seat of a person who seems to be congenial” and “a seat of a person who seems to be uncongenial” may be clearly stated too on the basis of congeniality degrees.

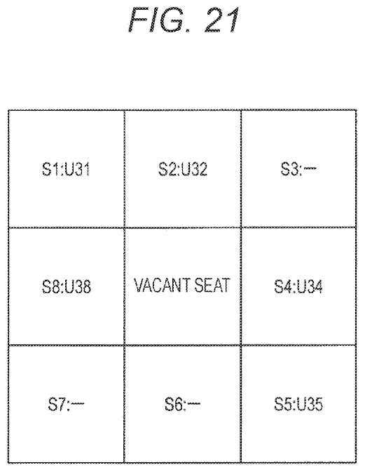

Calculation of a congeniality degree of such a vacant seat will be specifically described with reference to FIG. 21.

FIG. 21 is a drawing illustrating calculation of a congeniality degree of a vacant seat according to the present example. As shown in FIG. 21, there is assumed a case where seats [S1, S2, S3, S4, S5, S6, S7, S8] exist around a certain vacant seat, the seats [S3, S6, S7] are vacant seats, and the other seats are booked by users.

In this case, the congeniality management server 2 (or the service providing server 3C) selects a user from a list [U31, U32, U34, U35, U38] of users who have booked seats, and determines a congeniality degree. In a case where congeniality information of congeniality between the user who has made the request and the user who has booked exists in congeniality information of congeniality between individuals, a congeniality degree is obtained from the congeniality information of congeniality between individuals. If not, a congeniality degree is obtained from congeniality information of congeniality between character types by using a character type of the user who has made the request, which can be obtained from user information, and a character type of the user who has booked.

The congeniality degree of the vacant seat can be determined as, for example, an average of congeniality degrees of the surrounding seats. Alternatively, in a case where the surrounding seats are booked by at least one person, the congeniality degree of which is lower than a predetermined value (lower limit value), the vacant seat or the screening for this time may be prevented from being recommended.

In the present example, the example in which the congeniality information of the room-sharing service is applied to the seat recommendation service of movie appreciation has been described above.

It should be noted that the present example is not limited to this, and the congeniality information can be used between other various sharing services. For example, the congeniality information can also be used in a service for providing a comfortable stay with congenial house mates in a private rental lodging, or a service for providing a comfortable trip in consideration of congeniality to seatmates in an airplane, a train, or the like.

### 5. Summary

As described above, in the information processing system according to the embodiment of the present disclosure, various service requests can be fulfilled on the basis of obtained congeniality information of sharing service users without imposing a burden on each user and a sharing service provider.

The preferable embodiments of the present disclosure have been described in detail as above with reference to the accompanying drawings. However, the present technology is not limited to the above-described examples. It is clear that those who have ordinary skills in the technical field of the present disclosure can conceive of various correction examples or modification examples within the category of the technical idea set forth in the claims. It should be understood that, as a matter of course, these examples also belong to the technical scope of the present disclosure.

For example, it is also possible to create a computer program that causes hardware such as a CPU, a ROM and a RAM, the hardware being built into the user terminal 1, the congeniality management server 2 or the service providing server 3, to fulfill the function of the user terminal 1, the congeniality management server 2 or the service providing server 3. In addition, a computer-readable storage medium that stores the computer program is also provided.

Furthermore, the effects described in the present description are to be construed as merely descriptive or illustrative, and are not limitative. In other words, the technology according to the present disclosure can achieve, along with or instead of the above effects, other effects apparent to a person skilled in the art from the statement of the present description.

It should be noted that the present technology can also employ the following configurations.
(1)
A service information providing system operated by a service company that provides a service to a plurality of users who shares the same space in the same time zone, the service information providing system including:
a storage unit that stores congeniality information indicating congeniality between a plurality of users, the congeniality information being generated on the basis of sensor data obtained by sensing the plurality of users who is using a service;
a communication unit that receives a service request from a user; and
a control unit that performs control in such a manner that on the basis of congeniality information of congeniality of the user to other users, the congeniality information having already been stored in the storage unit, service provision information corresponding to the service request is provided through the communication unit.
(2)
The service information providing system set forth in the preceding (1), in which the control unit performs control in such a manner that on the basis of congeniality information of congeniality of the user to other users, the congeniality information having already been stored in the storage unit, service provision information related to a service corresponding to the service request is provided to the user through the communication unit, the service provision information including congeniality information of congeniality to other users who enjoy the service together.
(3)
The service information providing system set forth in the preceding (2), in which in a case where the storage unit does not store congeniality information of congeniality of the user to other users who enjoy the service together, the control unit estimates, according to information related to the user, congeniality information of congeniality to other users who enjoy the service together.
(4)
The service information providing system set forth in the preceding (3), in which the information related to the user includes character type information.
(5)
The service information providing system set forth in any one of the preceding (1) to (4), in which
the service information providing system provides service information related to a ride-sharing service;
the storage unit stores congeniality information indicating congeniality between a plurality of users, the congeniality information having been generated on the basis of sensor data obtained when a user uses the ride-sharing service together with other users; and
the control unit performs control in such a manner that when the communication unit receives a service request for enjoying the same ride-sharing service from the user, from congeniality information that is associated with the user and is stored in the storage unit, such a use schedule that does not share the same vehicle in the same time zone with other users who are estimated to be relatively uncongenial is provided to the user as service provision information.
(6)
The service information providing system set forth in the preceding (5), in which in order to fulfill the service request, when it is necessary to provide such a service that shares the same vehicle in the same time zone with another user who is estimated to be relatively uncongenial to the user, the control unit provides, as service provision information, such a use schedule in which still another user also rides together.
(7)
The service information providing system set forth in the preceding (5), in which the control unit provides, as service provision information, such a use schedule in which the user does not have a seat next to the another user.
(8)
The service information providing system set forth in any one of the preceding (1) to (7), in which
the control unit performs control in such a manner that on the basis of congeniality information of congeniality of the user to other users, the congeniality information having been obtained when a service that differs from the service for which the service request has been made has been used in the past, the congeniality information having already been stored in the storage unit, service provision information corresponding to the service request is provided through the communication unit.
(9)
A service information providing system that provides, to a service information providing server operated by a service company that provides a service to a plurality of users who shares the same space in the same time zone, congeniality information of congeniality between the plurality of users who uses the service, the service information providing system including:
a storage unit that stores congeniality information indicating congeniality between a plurality of users, the congeniality information being generated on the basis of sensor data obtained by sensing the plurality of users who is using a service;
a communication unit that, corresponding to a service request from a user, receives information for identifying the user and other users who enjoy the service together with the user, through the service information providing server; and
a control unit that performs control in such a manner that on the basis of congeniality information of congeniality of the user to other users, the congeniality information having already been stored in the storage unit, congeniality information of congeniality of the user to other users who enjoy the service together is provided to the service information providing server through the communication unit.
(10)
The service information providing system set forth in the preceding (9), in which the control unit performs control in such a manner that on the basis of congeniality information of congeniality of the user to other users, the congeniality information having been obtained when a service related to other service information providing servers has been used in the past, the congeniality information having already been stored in the storage unit, congeniality information of congeniality of the user to other users who enjoy the service together is provided to the service information providing server through the communication unit.
(11)
A method for controlling a service information providing system operated by a service company that provides a service to a plurality of users who shares the same space in the same time zone, the method being executed by a processor and including the steps of:
storing, in a storage unit, congeniality information indicating congeniality between a plurality of users, the congeniality information being generated on the basis of sensor data obtained by sensing the plurality of users who is using a service;
receiving a service request from a user by a communication unit; and
performing control in such a manner that on the basis of congeniality information of congeniality of the user to other users, the congeniality information having already been stored in the storage unit, service provision information corresponding to the service request is provided through the communication unit.
(12)
A method for controlling a service information providing system that provides, to a service information providing server operated by a service company that provides a service to a plurality of users who shares the same space in the same time zone, congeniality information of congeniality between the plurality of users who uses the service, the method being executed by a processor and including the steps of:
storing, in a storage unit, congeniality information indicating congeniality between a plurality of users, the congeniality information being generated on the basis of sensor data obtained by sensing the plurality of users who is using a service;
corresponding to a service request from a user, receiving, by a communication unit, information for identifying the user and other users who enjoy the service together with the user, through the service information providing server; and
performing control in such a manner that on the basis of congeniality information of congeniality of the user to other users, the congeniality information having already been stored in the storage unit, congeniality information of congeniality of the user to other users who enjoy the service together is provided to the service information providing server through the communication unit.

### REFERENCE SIGNS LIST

1 User terminal
2 Congeniality management server
3 Service providing server
10 Control unit
11 Communication unit
12 Input unit
13 Output unit
14 Storage unit
20 Control unit
21 Communication unit
22 Storage unit
30 Control unit
31 Communication unit
32 Storage unit

1. A service information providing system operated by a service company that provides a first service to a plurality of users who shares a same space in a same time zone comprising:
circuitry configured to:
store, in a storage, a plurality of congeniality information indicating congeniality between the plurality of users, wherein the plurality of congeniality information is based on sensor data associated with the plurality of users using the first service; and
transmit, a first use schedule as first service provision information, to a first user of the plurality of users, wherein
the first use schedule is for the first service, and
the first use schedule is transmitted based on a first service request from the first user and first congeniality information of the plurality of congeniality information, wherein
the first congeniality information corresponds to a congeniality between the first user and a second user of the plurality of users.

2. The service information providing system according to claim 1, wherein the first service provision information is related to a ride-sharing service,
the circuitry is further configured to:
determine the second user is congenial to the first user based on the first congeniality information, and
transmit, as the first service provision information, the first use schedule based on the first service request,
wherein in the first use schedule, the first user shares a same vehicle at a same time with the second user.

3. The service information providing system according to claim 1, wherein the first service provision information is related to a ride-sharing service,
the circuitry is further configured to:
determine the second user is uncongenial to the first user based on the first congeniality information, and
transmit, as the first service provision information, the first use schedule based on the first service request,
wherein in the first use schedule, the first user does not share a same vehicle at a same time with the second user.

4. The service information providing system according to claim 1, wherein
the circuitry is further configured to provide a second use schedule as the first service provision information to fulfill the first service request, in a case where a service is provided in which the first user shares a same vehicle at a same time with the second user, who is uncongenial to the first user,
wherein in the second use schedule, the second user rides together with the first user.

5. The service information providing system according to claim 4, wherein the circuitry is further configured to provide, as the first service provision information, the second use schedule in which the first user does not have a seat next to the second user.

6. The service information providing system according to claim 1, wherein
the circuitry is further configured to:
determine a character type of each user of the plurality of users based on the sensor data, and
store, in the storage, the character type of each user of the plurality of users.

7. The service information providing system according to claim 6, wherein
the circuitry is further configured to:
determine, in an event the first congeniality information is not stored, a congeniality degree of congeniality between a first character type of the first user and a second character type of the second user, and
transmit the first service provision information corresponding to the first service request based on the determined congeniality degree of congeniality.

8. The service information providing system according to claim 7, further comprising a plurality of sensors configured to measure, during a provision of the first service to the plurality of users, the sensor data associated with the plurality of users, wherein
the plurality of sensors includes:
a living-body sensor configured to measure living-body sensor data of at least one user of the plurality of users,
a camera configured to capture an image of the at least one user, and
a microphone configured to measure voice data of the at least one user,
the living-body sensor data includes information related to at least one of a pulse, a heart rate, or respiration of the at least one user, and
the sensor data includes the captured image, the voice data, and the living-body sensor data.

9. The service information providing system according to claim 8, wherein
the circuitry is further configured to generate at least one congeniality information of the plurality of congeniality information associated with the at least one user,
wherein the at least one congeniality information is generated based on at least one of a speaking time of the at least one user from the voice data, a speaking time ratio, or the heart rate of the at least one user from the living-body sensor data.

10. The service information providing system according to claim 8, wherein
the circuitry is further configured to:
determine, based on the captured image, a smile co-occurrence time that indicates a length of time in which the at least one user and another user of the plurality of users, smile together during the provision of the first service,
determine, based on the captured image, a time period in which a degree of a smile, of the at least one user and the other user, exceeds a threshold value,
determine a temporal change in the smile of the at least one user based on the determined time period in which the degree of the smile of the exceeds the threshold value,
determine, based on the living-body sensor data, a change in the heart rate of the at least one user during the provision of the first service, and
calculate a plurality of character type parameters based on the determined temporal change in the smile of the at least one user, the determined change in the heart rate of the at least one user, and the determined smile co-occurrence time, wherein
the character type of each user of the plurality of users is determined based on a first value of a first character type parameter of the plurality of character type parameters and a second value of a second character type parameter of the plurality of character type parameters.

11. The service information providing system according to claim 1, wherein
the circuitry is further configured to:
receive, a second service request from the first user for a second service,
wherein the second service differs from the first service, and—
transmit second service provision information corresponding to the second service request based on the first congeniality information.

12. A method for controlling a service information providing system, the method comprising:
storing, by a circuitry of the service information providing system, in a storage, a plurality of congeniality information indicating congeniality between a plurality of users, wherein
the plurality of congeniality information is based on sensor data associated with the plurality of users using a service, and
the service is provided by the service information providing system; and
transmitting, by the circuitry, a use schedule as service provision information, to a first user of the plurality of users, wherein
the use schedule is for the service, and
the use schedule is transmitted based on a service request from the first user and first congeniality information of the plurality of congeniality information, wherein
the first congeniality information corresponds to a congeniality between the first user and a second user of the plurality of users.

13. A non-transitory computer-readable medium having stored thereon, computer-executable instructions which, when executed by a computer, cause the computer to execute operations, the operations comprising:
storing, in a storage, a plurality of congeniality information indicating congeniality between a plurality of users, wherein the plurality of congeniality information is based on sensor data associated with the plurality of users using a service; and
transmitting, a use schedule as service provision information, to a first user of the plurality of users, wherein
the use schedule is for the service, and
the use schedule is transmitted based on a service request from the first user and first congeniality information of the plurality of congeniality information, wherein
the first congeniality information corresponds to a congeniality between the first user and a second user of the plurality of users.
